(19) United States
(12) Patent Application Publication
(10) Pub. No.: US 2021/0097496 A1
(43) Pub. Date: Apr. 1, 2021

(54) Method and Apparatus for Managing Resume Information, and Method and Apparatus for Managing Recruitment Information

(71) Applicant: DINGTALK HOLDING (CAYMAN) LIMITED, Grand Cayman (KY)

(72) Inventors: Hang Chen, Hangzhou (CN); Yulei Shi, Hangzhou (CN); Yi Zhang, Hangzhou (CN); Zhongkun Huang, Hangzhou (CN); Guangqian Dong, Hangzhou (CN); Yuan Zhang, Hangzhou (CN); Guiju Gao, Hangzhou (CN); Chenlu Guo, Hangzhou (CN)

(21) Appl. No.: 17/118,489

(22) Filed: Dec. 10, 2020

Related U.S. Application Data
(63) Continuation of application No. PCT/CN2019/089771, filed on Jun. 3, 2019.

(30) Foreign Application Priority Data
Jun. 11, 2018 (CN) 201810597276.0

(51) Int. Cl. G06Q 10/10; G06Q 50/20; G06F 3/0484; G06F 3/0488

(52) U.S. Cl. CPC G06Q 10/1053; G06F 3/0488; G06F 3/04845; G06Q 50/2057

(57) ABSTRACT

Methods and apparatuses for managing resume information and recruitment information are provided. A method for managing resume information may include playing multimedia introduction information included in an resume of an applicant; and displaying a detailed content of the resume in response to a confirmation trigger implemented by the applicant on the multimedia introduction information.

### CROSS REFERENCE TO RELATED PATENT APPLICATIONS

This application claims priority to and is a continuation of PCT Patent Application No. PCT/CN2019/089771 filed on 3 Jun. 2019, and is related to and claims priority to Chinese Application No. 201810597276.0, filed on 11 Jun. 2018 and entitled “Methods for Managing Resume Information, and Methods and Apparatuses for Managing Recruitment Information,” which are hereby incorporated by reference in their entirety.

### TECHNICAL FIELD

The present disclosure relates to the technical field of information management, and particularly to methods and apparatuses for managing resume information, and methods and apparatuses for managing recruitment information.

### BACKGROUND

In related technologies, after publishing recruitment information, a recruiter can receive resumes of candidate users through a mailbox or recruitment platform, and preliminarily determine whether corresponding applicants satisfy relevant recruitment requirements by reading detailed content of the resumes, thereby determining whether further communications (such as a telephone interview or on-site interview) with the applicants are needed.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In implementations, the present disclosure provides a method for managing resume information, a method and an apparatus for managing recruitment information.

To achieve the foregoing objectives, the present disclosure provides technical solutions as follows.

In implementations, the present disclosure provides a method for managing resume information, which includes:
playing multimedia introduction information included in an resume of an applicant; and
displaying a detailed content of the resume in response to a confirmation trigger implemented by the applicant on the multimedia introduction information.

In implementations, the present disclosure provides a method for managing resume information, which includes:
sending multimedia introduction information included in an resume of an applicant to a recruiter for viewing by the recruiter; and
sending a detailed content of the resume to the recruiter for viewing by the recruiter in response to a confirmation trigger of the multimedia introduction information implemented by the recruiter.

In implementations, the present disclosure provides a method for managing recruitment information, which includes:
playing multimedia introduction information included in recruitment information; and
displaying a detailed content of the recruitment information in response to a confirmation trigger implemented by an applicant on the multimedia introduction information.

In implementations, the present disclosure provides a method for managing resume information, which includes:
playing multimedia introduction information included in an resume of an applicant on a display of a device; and
displaying a detailed content of the resume when a touch sliding operation toward a first direction is detected on the screen of the device.

In implementations, the present disclosure provides a method for managing recruitment information, which includes:
playing multimedia introduction information included in recruitment information on a display of a device; and
displaying a detailed content of the recruitment information when a touch sliding operation toward a first direction is detected on the screen of the device.

In implementations, the present disclosure provides an apparatus for managing resume information, which includes:
a play unit that plays multimedia introduction information contained in an resume of an applicant; and
a detail display unit that displays a detailed content of the resume in response to a confirmation trigger implemented by a recruiter on the multimedia introduction information.

In implementations, the present disclosure provides an apparatus for managing resume information, which includes:
a first sending unit that sends multimedia introduction information included in an resume of an applicant to a recruiter for viewing by the recruiter; and
a second sending unit that sends a detailed content of the resume to the recruiter for viewing by the recruiter in response to a confirmation trigger of the multimedia introduction information implemented by the recruiter.

In implementations, the present disclosure provides an apparatus for managing recruitment information, which includes:
a play unit that plays multimedia introduction information included in recruitment information; and
a display unit that displays a detailed content of the recruitment information in response to a confirmation trigger implemented by an applicant on the multimedia introduction information.

In implementations, the present disclosure provides an apparatus for managing resume information, which includes:
a play unit that plays multimedia introduction information included in an resume of an applicant on a display of a device; and
a display unit that displays a detailed content of the resume when a touch sliding operation toward a first direction is detected on the screen of the device.

In implementations, the present disclosure provides an apparatus for managing recruitment information, which includes:
a play unit that plays multimedia introduction information included in recruitment information on a display of a device; and
a display unit that displays a detailed content of the recruitment information when a touch sliding operation toward a first direction is detected on the screen of the device.

### BRIEF DESCRIPTION OF THE DRAWINGS

FIG. 1 is a schematic structural diagram of a recruitment system provided by exemplary embodiments.

FIG. 2A is a flowchart of an example method for managing resume information of a recruiter provided by the exemplary embodiments.

FIG. 2B is a flowchart of another example method for managing resume information of a recruiter provided by the exemplary embodiments.

FIG. 3 is a flowchart of an example method for managing resume information on a server side provided by the exemplary embodiments.

FIG. 4A is a flowchart of an example method for managing recruitment information provided by the exemplary embodiments.

FIG. 4B is a flowchart of another example method for managing recruitment information provided by exemplary embodiments.

FIG. 5 is a schematic diagram of an example guidance interface for filling in a resume provided by the exemplary embodiments.

FIGS. 6-7 are schematic diagrams of an example background information filling interface provided by the exemplary embodiments.

FIG. 8 is a schematic diagram of another example guidance interface for filling in a resume provided by the exemplary embodiments.

FIG. 9 is a schematic diagram of an example reference setting interface provided by the exemplary embodiments.

FIG. 10 is a schematic diagram of an example recruitment information display interface provided by the exemplary embodiments.

FIG. 11 is a schematic diagram of an example enterprise introduction video playing interface provided by the exemplary embodiments.

FIG. 12 is a schematic diagram of an example complete recruitment information display interface provided by the exemplary embodiments.

FIG. 13 is a schematic diagram of an example communication interface of an applicant provided by the exemplary embodiments.

FIG. 14 is a schematic diagram of an example communication interface of a recruiter provided by the exemplary embodiments.

FIG. 15 is a schematic diagram of an example applicant introduction video playing interface provided by the exemplary embodiments.

FIG. 16 is a schematic diagram of another example communication interface of an applicant provided by the exemplary embodiments.

FIG. 17 is a schematic diagram of another example communication interface of a recruiter provided by the exemplary embodiments.

FIG. 18 is a schematic diagram of an example resume display interface provided by the exemplary embodiments.

FIG. 19 is a schematic diagram of an example multi-party relationship involved in a school recruitment scenario of an instant messaging application provided by the exemplary embodiments.

FIG. 20 is a schematic diagram of an example employment statistics display interface provided by the exemplary embodiments.

FIG. 21 is a schematic diagram of an example school recruitment assistant interface provided by the exemplary embodiments.

FIG. 22 is a schematic structural diagram of an example device of a recruiter provided by the exemplary embodiments.

FIG. 23 is a block diagram of an example apparatus for managing resume information of a recruiter provided by the exemplary embodiments.

FIG. 24 is a block diagram of another example apparatus for managing resume information of a recruiter provided by the exemplary embodiments.

FIG. 25 is a schematic structural diagram of an example server-side device provided by the exemplary embodiments.

FIG. 26 is a block diagram of an example apparatus for managing resume information on a server side provided by the exemplary embodiments.

FIG. 27 is a schematic structural diagram of an example device provided by the exemplary embodiments.

FIG. 28 is a block diagram of an example apparatus for managing recruitment information provided by the exemplary embodiments.

FIG. 29 is a block diagram of another example apparatus for managing recruitment information provided by the exemplary embodiments.

### DETAILED DESCRIPTION

Exemplary embodiments are described in detail herein, and examples thereof are shown in the accompanying drawings. When the drawings are referred in the following description, the same numbers in different drawings indicate the same or similar elements unless indicated otherwise. Implementations described in the following exemplary embodiments do not represent all implementations that are consistent with the present disclosure, but are merely examples of apparatuses and methods that are consistent with some aspects of the present disclosure as detailed in the appended claims.

It should be noted that, in other embodiments, steps of corresponding methods may not necessarily be executed in the order that is shown and described in the present disclosure. In other embodiments, method thereof may include more or fewer steps than those described in the present disclosure. In addition, a single step described in the present disclosure may be decomposed into multiple steps in other embodiments for description, and multiple steps described in the present disclosure may also be combined into a single step in other embodiments for description.

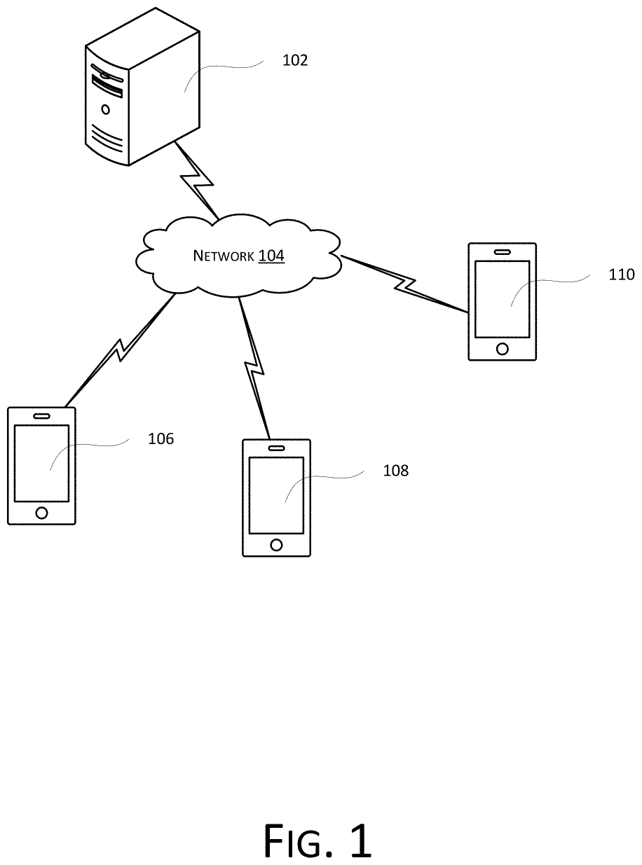

FIG. 1 is a schematic structural diagram of a recruitment system 100 provided by the exemplary embodiments. As shown in FIG. 1, the system 100 may include a server 102, a network 104, and a number of electronic devices, such as a mobile phone 106, a mobile phone 108, and a mobile phone 110.

The server 102 may be a physical server including an independent host computer. Alternatively, the server 102 may be a virtual server included in a host cluster. During operation, the server 102 may run a program of an application on a server side to implement relevant service functions of the application. For example, when running a program of a mobile group office platform, the server 102 can be implemented as a server end of the mobile group office platform. In technical solutions of the one or more embodiments of the present specification, the server 102 can cooperate with client ends running on the mobile phones 106-110 to implement management solutions for recruitment information or resume information.

In implementations, a mobile group office platform can not only implement communication functions, but also serve as an integrated functional platform for a plurality of other functions, for example, processing of internal events of a group, such as approval events (such as leaves, office item applications, financial approval events, etc.), attendance events, task events, log events, and processing of external events of a group, such as meal ordering, purchasing, etc., which are not limited by the present disclosure. In the technical solutions of the present disclosure, the mobile group office platform can be used to implement a recruitment function, so that a recruiter can post recruitment information, receive resumes of applicants, and manage the corresponding resumes through the recruitment function, to optimize recruitment and job application processes in related technologies.

In implementations, the mobile group office platform can be hosted in an instant messaging application in related technologies, such as Enterprise Instant Messaging (EIM) applications, such as Skype For Business®, Microsoft Teams®, Yammer®, Workplace®, Slack®, Enterprise WeChat®, FunShare®, Enterprise Fetion®, Enterprise Yixin®, etc. Apparently, an instant messaging function is only one of a plurality of communication functions supported by the mobile group office platform. The mobile group office platform can also implement more other functions such as those mentioned above, which are not repeated herein. Therefore, when implementing a resume information management solution or a recruitment information management solution of the present disclosure, the mobile group office platform can not only provide convenient recruitment and job application functions, but also achieve efficient communications between a recruiter and an applicant.

The mobile phones 106-110 are just a type of electronic devices that can be used by recruiters and applicants. In fact, recruiters and applicants can obviously also use electronic devices such as the following types: tablet devices, laptops, PDAs (Personal Digital Assistants), wearable devices (such as smart glasses, smart watches, etc.), etc., which are not limited by the present disclosure. During operation, the electronic device can run a program of an application on a client side to implement relevant service functions of the application. For example, when a program of a mobile group office platform is run by the electronic device, it can be implemented as a client end of the mobile group office platform.

It should be pointed out that an application of a client end of a mobile group office platform can be pre-installed on an electronic device, so that the client end can be started and run on the electronic device. Apparently, when using an online “customer end” of HTML5 technology is used, for example, the client end can be obtained and run without installing the corresponding application on the electronic device.

The network 104 through which interactions between the mobile phones 106-110 and the server 102 are conducted may include multiple types of wired or wireless networks. In implementations, the network 104 may include a Public Switched Telephone Network (PSTN) and the Internet.

Therefore, a recruiter can publish recruitment information through a client end running on an electronic device thereof. An applicant can manage recruitment information (such as viewing, screening, etc.) through a client end running on an electronic device thereof, and upload his/her resume for recruitment information of interest. The recruiter can manage the received resume through the client end running on the electronic device thereof (such as viewing, screening, etc.).

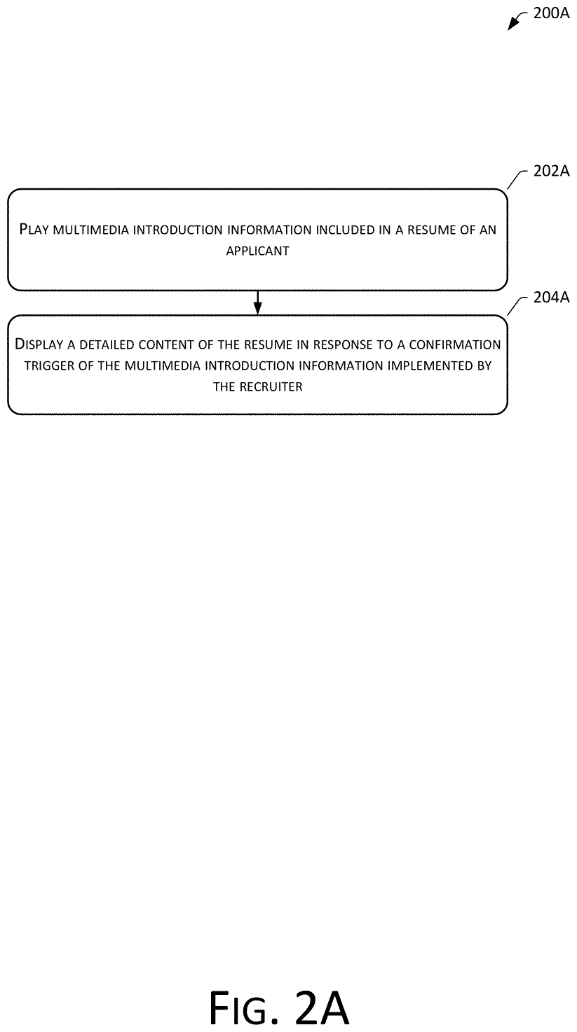

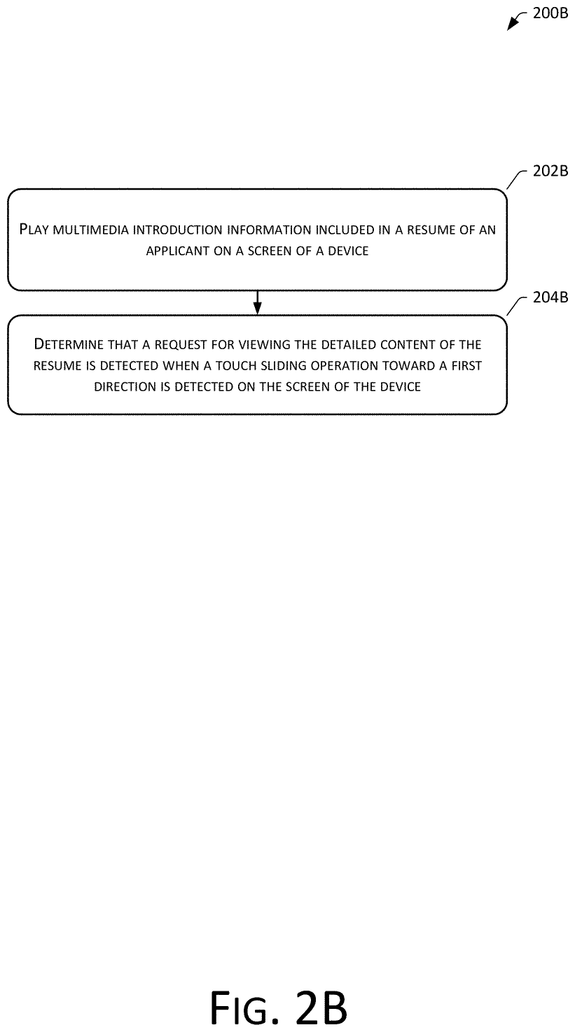

FIG. 2A is a flowchart of a method 200A for managing resume information of a recruiter according to the exemplary embodiments. As shown in FIG. 2A, the method 200A is applied to an electronic device of a recruiter and may include the following steps:

Step 202A: Play multimedia introduction information included in an resume of an applicant.

In implementations, an electronic device on a recruiter user side may display candidate users to the recruiter, determine applicants according to the recruiter's selection result of the candidate users, and thereby play multimedia introduction information included in resumes of the applicants.

In implementations, the candidate users may have multiple sources. For example, when the technical solutions in the present disclosure are implemented based on a certain application, an electronic device on a recruiter user side and an electronic device on an applicant user side can run separately client ends of that application, and a server can run a server end of the application. The recruiter can then set recruitment requirements (setting the recruitment requirements separately, or including the recruitment requirements in recruitment information) through the client end running on the electronic device on the recruiter user side. The server can automatically find resumes that match the above recruitment requirements, and users to which the found resumes belong can be recommended to the recruiter as system recommendations. For another example, the recruiter may have associated users such as colleagues and friends. Electronic devices used by these associated users can run client ends of the above application, and recommend other users' resumes to the recruiter through the client ends. The recommended users are internally recommendations.

In implementations, by actively setting filtering conditions, etc., the recruiter can conduct a search for resumes provided by the client end of the above application to find resumes that match the filtering conditions, so that the electronic device on the recruiter user side can play multimedia introduction information included in the found resumes.

In implementations, the multimedia introduction information may include at least one of the following: video information, virtual reality information, augmented reality information, mixed reality information, and mediated reality information, which are not limited by the present disclosure. When the multimedia introduction information is ordinary video information, electronic devices such as mobile phones and PCs with video playing functions can play the multimedia introduction information. When the multimedia introduction information is a type such as virtual reality information, augmented reality information, mixed reality information, mediated reality information, etc., the electronic device on the recruiter user side needs to have functions of playing and displaying relevant types of multimedia introduction information.

In implementations, when the multimedia introduction information is played, the electronic device on the recruiter user side may display an introduction content included in the resume of the applicant, so that the recruiter has a more comprehensive understanding of the applicant's situation.

Step 204A: Display a detailed content of the resume in response to a confirmation trigger of the multimedia introduction information implemented by the recruiter.

In implementations, since a detailed content of an resume is usually expressed in a textual form, it is not conducive for the recruiter to have a quick view. The multimedia introduction information, compared to the textual form, is easier to be quickly understood by the recruiter. Especially when being faced with a large number of resumes, the recruiter can quickly select the applicants that are of interest by viewing multimedia introduction information, and screen out most of the applicants that are not of interest. Furthermore, when reviewing detailed contents of resumes of the applicants that are of interest, this greatly reduces the amount of text read by the recruiter, thus helping to improve the efficiency of processing corresponding resumes by the recruiter.

In implementations, to protect the privacy of applicants, the recruiter is set to have no browsing permission for detailed contents of resumes by default, especially contact information of applicants included in the detailed contents (such as a name, a mobile phone number, an email address, a home address, a date of birth, an identification card number, etc.), and can only view corresponding multimedia introduction information, and an introduction content, etc., included in the resumes. These pieces of information are often enough for the recruiter to perform screening for applicants. When the recruiter is interested in an applicant, a confirmation trigger of corresponding multimedia introduction information can be implemented. Accordingly, in response to the confirmation trigger of the recruiter on the multimedia introduction information, the electronic device on a recruiter user side may send a detailed content viewing request to the applicant. According to a confirmation response of the applicant for the detailed content viewing request, the recruiter obtains a browsing permission for a detailed content of the resume, and the electronic device on the recruiter user side can display the detailed content of the resume.

In implementations, the electronic device on the recruiter user side may obtain the entire resume. However, when the recruiter does not have the browsing permission, only multimedia introduction information, introduction information, etc. is displayed, and the detailed content is restricted to display. When the recruiter obtains the browsing permission, the electronic device on the recruiter user side can display the detailed content.

In implementations, when the recruiter does not have the browsing permission, the electronic device on the recruiter user side may only obtain the multimedia introduction information, introduction information, etc. in the resume. After the recruiter obtains the browsing permission, the electronic device on the recruiter user side can obtain and display the detailed content.

In implementations, it is assumed that the electronic device on the recruiter user side plays the multimedia introduction information of the applicant on a first display interface. After responding to the confirmation trigger implemented by the recruiter on the multimedia introduction information, the electronic device on the recruiter user side can switch from the first display interface to a second display interface for a detailed content of the resume. In this case, the recruiter can continuously view the multimedia introduction information and the detailed content of the same applicant.

In implementations, it is assumed that the electronic device on the recruiter user side plays the multimedia introduction information of the applicant on a first display interface. After responding to the confirmation trigger implemented by the recruiter on the multimedia introduction information, the electronic device on the recruiter user side can obtain a detailed content of the resume on the one hand, and switch from the first display interface to a second display interface of multimedia introduction information of another applicant on the other hand. In other words, the electronic device on the recruiter user side completes an acquisition of the detailed content in the background, and switches in the front end from the first display interface to the second display interface that is irrelevant to the detailed content, so that the recruiter can successively view multimedia introduction information of multiple applicants, thereby separating “viewing multimedia introduction information” and “viewing detailed content” into two parts for processing. When the recruiter wants to view the above-mentioned detailed content, the electronic device on the recruiter user side can then switch to the display interface for the detailed content information of the resume according to a trigger operation of the recruiter on the detailed content of the resume.

In implementations, the electronic device on the recruiter user side may send a verification request to a predefined verification platform, so that the predefined verification platform verifies at least one piece of resume content of the applicant. For example, when the resume content of the applicant includes “graduate of XX College of XX University in 2018”, a verification request can be sent to the predefined verification platform to verify an identity of such student.

In implementations, the electronic device on the recruiter user side may send a verification request to a verified user of the predefined verification platform, so that the verified user can verify at least one piece of resume content of the applicant. The verified user is an associated user of the applicant. For example, when a resume content of an applicant includes “graduate of XX College of XX College in 2018”, if the recruiter knows that a certain user X is also “graduate of XX College of XX College in 2018”, the recruiter can send a verification request to the user X to request the user X to assist in verifying the student identity of the applicant.

In implementations, the electronic device on the recruiter user side may have a communication function, so that communication messages can be exchanged between the recruiter and applicants. For example, the electronic device on a recruiter user side can be configured as a client end of a mobile group office platform. The client end can not only realize management of resume information in the present disclosure, but also be compatible with communication functions, so that the recruiter can quickly communicate with applicants while viewing the resume, without repeatedly switching between multiple applications, thus helping to improve the efficiency.

In implementations, the electronic device on the recruiter user side can display information of a reference included in a resume of an applicant. The reference is usually a user related to the applicant and has certain prestige, such as a business leader, an industry elite, etc., and may endorse the ability, etc., of the applicant, so that the recruiter may have a higher degree of trust of content of the resume.

In implementations, a client end of an instant messaging application may be running on the electronic device, i.e., the electronic device is configured as a client device of the instant messaging application. By improving functions of the instant messaging application, the client device can be used to implement a resume information management as shown in FIG. 2A, so that the recruiter can quickly view and manage resume information based on the client device, and combine the resume information management function with an instant messaging function of the instant messaging application. For example, the detailed content viewing request can quickly be sent to the applicant using the instant messaging function, and the applicant is enabled to realize a rapid feedback through the instant messaging function. Meanwhile, the recruiter and the applicant can realize convenient and efficient communications through this instant messaging application, which further simplifies the process of recruitment and helps to improve the efficiency of recruitment.

FIG. 2B is a flowchart of another method 200B for managing resume information of a recruiter on a user side provided by the exemplary embodiments. As shown in FIG. 2B, the method 200B is applied to an electronic device on a recruiter user side, and may include the following steps:

Step 202B: Play multimedia introduction information included in a resume of an applicant on a screen of a device.

In implementations, multimedia introduction information may have multiple sources. For example, when the exemplary embodiments are implemented based on a certain application, an electronic device on a recruiter user side and an electronic device on an applicant user side can run separately client ends of that application, and a server can run a server end of the application. The recruiter can then set recruitment requirements (setting the recruitment requirements separately, or including the recruitment requirements in recruitment information) through the client end running on the electronic device on the recruiter user side. The server can automatically find resumes that match the above recruitment requirements, and thus the above multimedia introduction information comes from the resumes that are found. For another example, the recruiter may have associated users such as colleagues and friends, etc. Client ends of the application can be run in electronic devices used by these associated users, and resumes of other users are recommended to the recruiter through those client ends. In this case, the multimedia introduction information comes from resumes of the users that are recommended. For another example, the recruiter can search for resumes configured on client ends of the above application through setting filtering conditions on his own initiative and etc., to find resumes that match the filtering conditions. The above multimedia introduction information thus comes from resumes that are found.

In implementations, the multimedia introduction information may include at least one of the following: video information, virtual reality information, augmented reality information, mixed reality information, and mediated reality information, which are not limited by the present disclosure. When the multimedia introduction information is ordinary video information, electronic devices such as mobile phones and PCs with video playing functions can play the multimedia introduction information. When the multimedia introduction information is a type such as virtual reality information, augmented reality information, mixed reality information, mediated reality information, etc., the electronic device on the recruiter user side needs to have functions of playing and displaying relevant types of multimedia introduction information.

In implementations, when the multimedia introduction information is played, the electronic device on the recruiter user side may display an introduction content included in the resume of the applicant, so that the recruiter has a more comprehensive understanding of conditions of the applicant.

Step 204B: Determine that a request for viewing the detailed content of the resume is detected when a touch sliding operation toward a first direction is detected on the screen of the device.

In implementations, when having the browsing permission for a detailed content of the resume, the electronic device on the recruiter user side may display the detailed content of the resume in response to a viewing request. Since a detailed content of an resume is usually expressed in a textual form, it is not conducive for the recruiter to have a quick view. The multimedia introduction information is easier to be quickly understood by the recruiter as compared to the textual form. Especially when being faced with a large number of resumes, the recruiter can quickly select the applicants that are of interest by viewing multimedia introduction information, and screen out most of the applicants that are not of interest. Furthermore, when reviewing detailed contents of resumes of the applicants that are of interest, this greatly reduces the amount of text read by the recruiter, thus helping to improve the efficiency of processing corresponding resumes by the recruiter.

In implementations, to protect the privacy of applicants, the recruiter is set to have no browsing permission for detailed contents of resumes by default, especially contact information of applicants included in the detailed contents (such as a name, a mobile phone number, an email address, a home address, a date of birth, an identification card number, etc.), and can only view corresponding multimedia introduction information, and an introduction content, etc., included in the resumes. These pieces of information are often enough for the recruiter to perform screening for applicants. When there is no browsing permission for the detailed content of the resume, the electronic device on the recruiter user side may initiate a detailed content viewing request to the applicant in response to a viewing request, so as to obtain the browsing permission for the detailed content of the resume based on a confirmation response of the detailed content viewing request from the applicant, and display the detailed content of the resume.

In implementations, the electronic device on the recruiter user side may obtain the entire resume. However, when the recruiter does not have the browsing permission, only multimedia introduction information, introduction information, etc. is displayed, and the detailed content is restricted to display. When the recruiter obtains the browsing permission, the electronic device on the recruiter user side can display the detailed content.

In implementations, when the recruiter does not have the browsing permission, the electronic device on the recruiter user side may only obtain the multimedia introduction information, introduction information, etc. in the resume of the applicant. When the recruiter obtains the browsing permission, the electronic device on the recruiter user side can obtain and display the detailed content.

In implementations, by implementing a touch sliding operation toward a first direction on a screen of a device, when the recruiter is interested in a resume to which multimedia introduction information belongs, the recruiter can quickly express his/her viewing request for a detailed content of the resume. The touch sliding operation can occur anywhere on the screen of the device, so that the recruiter does not need to find and locate an option or a button, etc., that is shown on the screen of the device, thus helping the recruiter to efficiently implement the touch sliding operation.

In implementations, in response to the viewing request, the electronic device on the recruiter user side may mark the resume as a selected resume. Moreover, the electronic device on the recruiter user side may switch from the content played in the screen of the device to multimedia introduction information included in an resume of another applicant. In other words, the electronic device on the recruiter user side does not need to immediately display the detailed content of the resume that the recruiter is interested in, but can continue to view multimedia introduction information of other resumes, so as to separate “view multimedia introduction information” and “view detailed content” into two parts for processing. As such, the recruiter can continuously check multimedia introduction information in a continuous period of time, and then separately check resumes that are marked as selected resumes. This helps maintain the continuity of work, thereby improving the efficiency of processing the corresponding resumes.

In implementations, when a touch sliding operation on the screen of the device is detected in a second direction that is different from the first direction, the electronic device on the recruiter user side may switch the content played in the screen of the device to multimedia introduction information included in a resume of another applicant. In other words, the recruiter can choose to implement a touch sliding operation toward the first direction or the second direction on the screen of the device according to the attention of a corresponding resume, so as to quickly express the attention of the above resume. The touch sliding operation can occur anywhere on the screen of the device, so that the recruiter does not need to find and locate an option or a button that is shown on the screen of the device, thus helping the recruiter to efficiently implement the touch sliding operation.

In implementations, in response to the touch sliding operation toward the second direction, the electronic device on the recruiter user side may mark the resume as a failed resume. Whether it is a selected resume or a failed resume, it is actually equivalent to adding a specific mark to a corresponding resume. This makes it easier for the recruiter to find relevant resumes afterwards on the one hand, and can provide reference to the server end on the other hand. As such, when resumes are recommended to the recruiter, the failed resumes are ignored, other resumes that are similar to the resume contents of the failed resumes are ignored or reduced, and other resumes that are similar to the resume contents of the selected resumes are added or preferentially selected.

In implementations, the electronic device on the recruiter user side may send a verification request to a predefined verification platform, so that the predefined verification platform verifies at least one piece of resume content of the applicant. For example, when the resume content of the applicant includes “graduate of XX College of XX University in 2018”, a verification request can be sent to the predefined verification platform to verify an identity of such student.

In implementations, the electronic device on the recruiter user side may send a verification request to a verified user of the predefined verification platform, so that the verified user can verify at least one piece of resume content of the applicant. The verified user is an associated user of the applicant. For example, when a resume content of an applicant includes “graduate of XX College of XX College in 2018”, if the recruiter knows that a certain user X is also “graduate of XX College of XX College in 2018”, the recruiter can send a verification request to the user X to request the user X to assist in verifying the student identity of the applicant.

In implementations, the electronic device on the recruiter user side may have a communication function, so that communication messages can be exchanged between the recruiter and applicants. For example, the electronic device on the recruiter user side can be configured as a client end of a mobile group office platform. The client end can not only realize management of resume information in the present disclosure, but also be compatible with communication functions, so that the recruiter can quickly communicate with applicants while viewing the resume, without repeatedly switching between multiple applications, thus helping to improve the efficiency.

In implementations, the electronic device on the recruiter user side can display information of a reference included in a resume of an applicant. The reference is usually a user related to the applicant and has certain prestige, such as a business leader, an industry elite, etc., and may endorse the ability, etc., of the applicant, so that the recruiter may have a higher degree of trust of content of a resume.

In implementations, a client end of an instant messaging application may be running on the electronic device, i.e., the electronic device is configured as a client device of the instant messaging application. By improving functions of the instant messaging application, the client device can be used to implement a resume information management solution such as the one shown in FIG. 2B, so that the recruiter can quickly view and manage resume information based on the client device, and combine the resume information management function with an instant messaging function of the instant messaging application. For example, the detailed content viewing request can quickly be sent to the applicant using the instant messaging function, and the applicant is enabled to realize a rapid feedback through the instant messaging function. At the same time, the recruiter and the applicant can realize convenient and efficient communications through this instant messaging application, which further simplifies the process of recruitment and helps to improve the efficiency of recruitment.

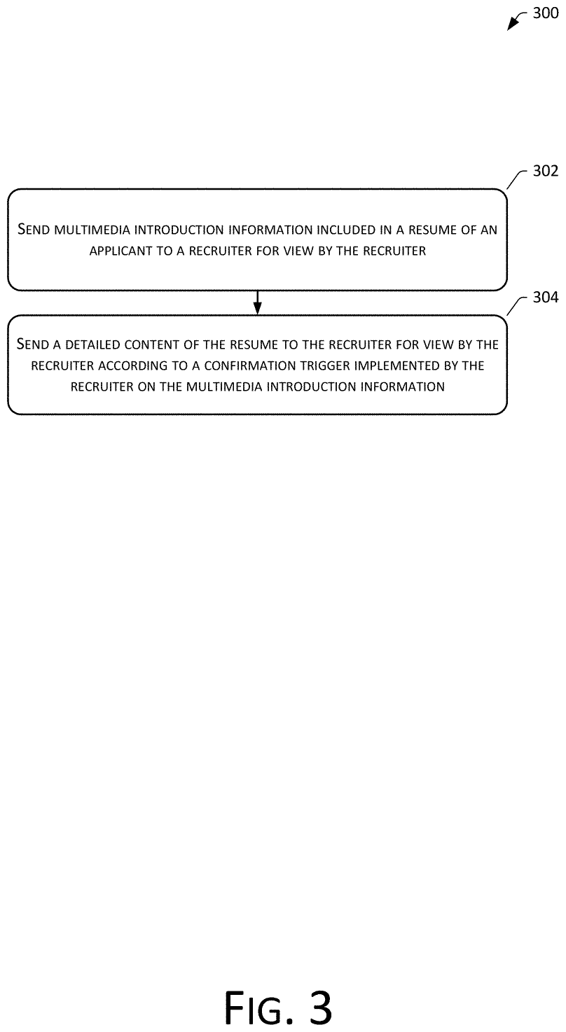

FIG. 3 is a flowchart of a method 300 for managing resume information on a server side provided by the exemplary embodiments. As shown in FIG. 3, the method 300 is applied to a server and may include the following steps:

Step 302: Send multimedia introduction information included in an resume of an applicant to a recruiter for view by the recruiter.

In implementations, the server may provide information of candidate users to the electronic device on the recruiter user side, so that the candidate users can be displayed to the recruiter for the recruiter to select. A selected candidate user is the above-mentioned applicant.

In implementations, for example, when the technical solutions of the present disclosure are implemented based on a certain application, an electronic device of a recruiter and an electronic device of an applicant can run client ends of the application, and a server can run a server side of the application. The recruiter can set recruitment requirements (set the recruitment requirements separately, or include the recruitment requirements in recruitment information) through the client end running on the electronic device on the recruiter user side, and the server end can automatically search for resumes that match the above recruitment conditions, and users of the found resumes are recommended to the recruiter as candidate users recommended by the system.

In an embodiment, multiple sources may exist for the candidate users. In addition to the candidate users recommended by the system, the recruiter may have colleagues, friends and other associated users. Electronic devices used by these associated users can run respective client ends of the above application, and recommend resumes of other users to the recruiter through the client ends. These recommended users are internally recommended candidate users. The associated users can report the internally recommended candidate users to the server, and the server sends a recommendation to the recruiter.

In implementations, the recruiter can search for resumes based on a client configuration of the above-mentioned application by actively setting filtering conditions, and the server can implement a search operation specifically to find resumes that match the filtering conditions. As such, the electronic device on the recruiter user side can play multimedia introduction information included in the found resumes.

In implementations, the multimedia introduction information may include at least one of the following: video information, virtual reality information, augmented reality information, mixed reality information, and mediated reality information, which is not limited in the present disclosure. When the multimedia introduction information is ordinary video information, electronic devices such as mobile phones and PCs with video playing functions can play the multimedia introduction information. When the multimedia introduction information is a type such as virtual reality information, augmented reality information, mixed reality information, or mediated reality information, the electronic device on the recruiter user side needs to have a function of playing and displaying relevant types of multimedia introduction information.

In implementations, the server may send introduction content included in an resume of an applicant to the electronic device on the recruiter user side. As such, when the electronic device on the recruiter user side plays the multimedia introduction information, the introduction content included in the resume of the applicant can be displayed, so that the recruiter has a more comprehensive understanding of the applicant's condition.

Step 304: Send a detailed content of the resume to the recruiter for view by the recruiter according to a confirmation trigger implemented by the recruiter on the multimedia introduction information.

In implementations, since a detailed content of an resume is usually expressed in a textual form, it is not conducive to a quick view by the recruiter. The multimedia introduction information is easier to be quickly understood by the recruiter as compared to the textual form. Especially when being faced with a large number of resumes, the recruiter can quickly select the applicants that are of interest by viewing multimedia introduction information, and screen out most of the applicants that are not of interest. Furthermore, when reviewing detailed contents of resumes of the applicants that are of interest, this greatly reduces the amount of text read by the recruiter, thus helping to improve the efficiency of processing corresponding resumes by the recruiter. Furthermore, for most applicants who are not of interest, since the server does not need to send detailed contents of corresponding resumes to the electronic device on the recruiter user side, an amount of data transmission between the server and the electronic device on the recruiter user side is reduced.

In implementations, to protect the privacy of applicants, the recruiter is set to have no browsing permission for detailed contents of resumes by default, especially contact information of applicants included in the detailed contents (such as a name, a mobile phone number, an email address, a home address, a date of birth, an identification card number, etc.), and can only view corresponding multimedia introduction information, and an introduction content, etc., included in the resumes. These pieces of information are often enough for the recruiter to perform screening for applicants. When the recruiter finds interests in an applicant, a confirmation trigger of corresponding multimedia introduction information can be implemented. Correspondingly, according to the confirmation trigger implemented by the recruiter on the multimedia introduction information, the electronic device on the recruiter user side can, for example, send a confirmation trigger message to the server accordingly. The server can send a detailed content viewing request to the applicant, and provide a browsing permission for a detailed content of the resume based on a confirmation response of the applicant for the detailed content viewing request, the electronic device on the recruiter user side can display the detailed content of the resume.

According to the confirmation trigger implemented by the recruiter on the multimedia introduction information, the server may send the detailed content of the resume to the electronic device on the recruiter user side before the applicant confirms and responds to the detailed content viewing request, so that the user recruiter can view corresponding detailed content as soon as possible without downloading data for the moment, after obtaining the browsing permission. Alternatively, the server may send the detailed content of the resume to the electronic device on the recruiter user side after determining that the applicant has confirmed and responded to the detailed content viewing request, so as to prevent the recruiter from obtaining the browsing permission through illegal means or reading the detailed content by forceful cracking.

In implementations, when the applicant actively sends a communication message to the recruiter, the applicant's resume is pushed to the recruiter, so that the recruiter can learn about the applicant's condition in time, which helps to improve the efficiency of communications between the recruiter and the applicant.

In implementations, when as many companies as possible conduct recruitment based on the technical solutions in the present disclosure, and as many users as possible are applying for jobs based on the technical solutions in the present disclosure, the server can conduct statistics on recruiters' employment information of applicants of specific colleges and universities, employment situations of students of specific colleges and universities are generated according to statistical results, which solves problems that each colleges and universities are often difficult to calculate the employment situations of students and statistical results are inaccurate.

In implementations, a server end of a certain instant messaging application may run on the server. In other words, the server is configured as a server device of the instant messaging application. By improving functions of the instant messaging application, the server device can be enabled to be used for implementing the resume information management solutions such as the one shown in FIG. 3, to provide a recruiter with multimedia introduction information and detailed contents included in resumes, to allow the recruiter to view and manage. Furthermore, a management function of resume information can be combined with an instant messaging function of the instant messaging application. For example, a recruiter can quickly send a detailed content viewing request as described above to an applicant through the instant messaging function, and enable the applicant to realize a rapid feedback through the instant messaging function. At the same time, the recruiter and the applicant can realize convenient and efficient communications through this instant messaging application, which further simplifies the process of recruitment and helps to improve the efficiency of recruitment.

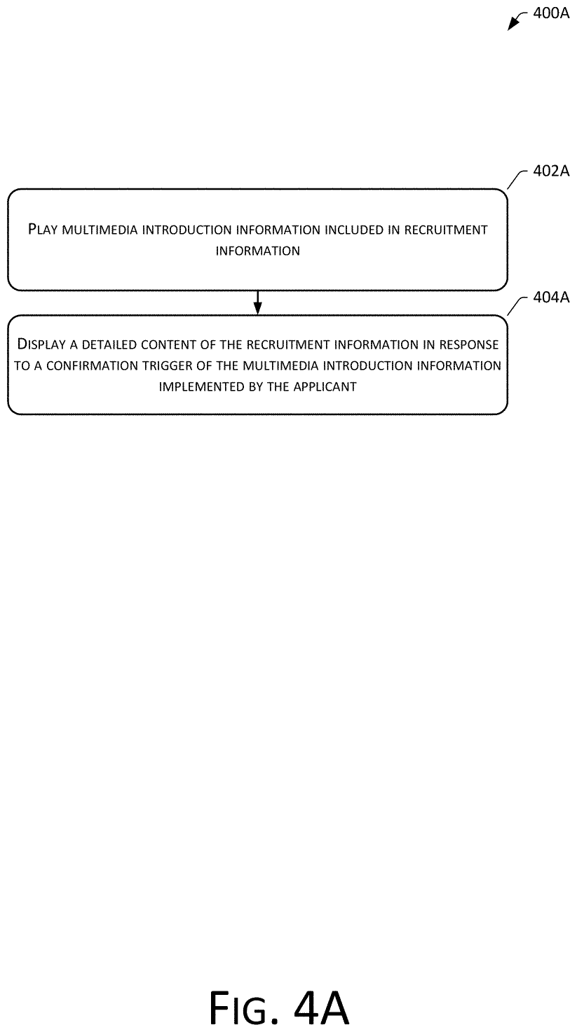

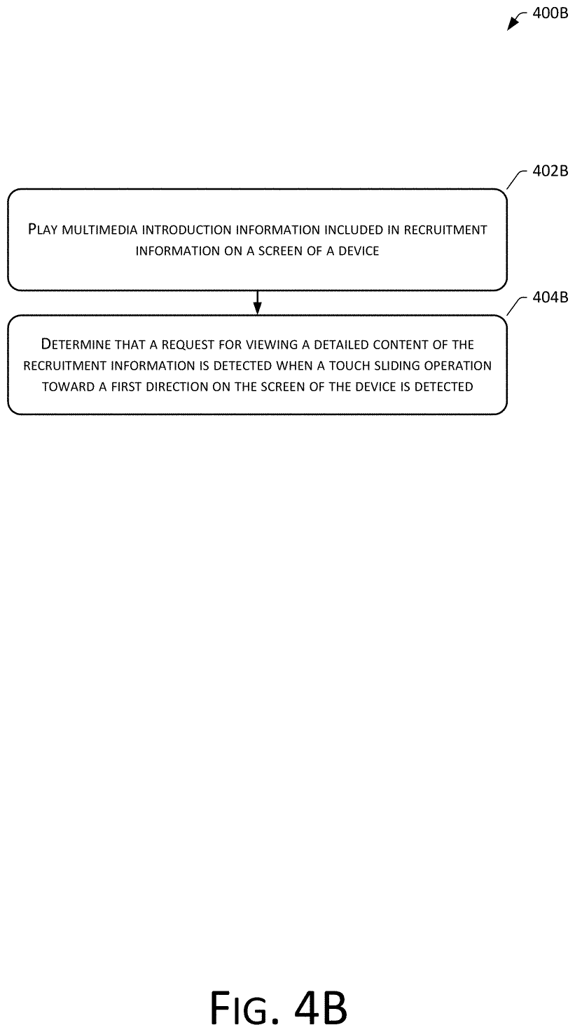

FIG. 4A is a flowchart of a method 400A for managing recruitment information provided by the exemplary embodiments. As shown in FIG. 4A, the method 400A is applied to an electronic device of an applicant, and may include the following steps:

Step 402A: Play multimedia introduction information included in recruitment information.

In implementations, recruitment information can be pushed by a server or other users to an electronic device of an applicant, so that the electronic device of the applicant can play multimedia introduction information included in the recruitment information. For example, after the applicant uploads an resume configured thereby, the server can automatically find recruitment information that matches the resume, and recommend the recruitment information to the applicant. For another example, after other users view recruitment information that is suitable for the applicant, the recruitment information can be shared to the applicant.

In implementations, the server may maintain a recruitment platform, which is used to display recruitment information submitted by recruiters. An applicant can browse the recruitment information on the recruitment platform through an electronic device of a user side of the applicant. The electronic device of the user side of the applicant plays multimedia introduction information included in the browsed recruitment information.

In implementations, the multimedia introduction information may include at least one of the following: video information, virtual reality information, augmented reality information, mixed reality information, and mediated reality information, which is not limited in the present disclosure. When the multimedia introduction information is ordinary video information, electronic devices such as mobile phones and PCs with video playing functions can play the multimedia introduction information. When the multimedia introduction information is a type such as virtual reality information, augmented reality information, mixed reality information, or mediated reality information, an electronic device of an applicant needs to have functions of playing and displaying relevant types of multimedia introduction information.

In implementations, the multimedia introduction information may include at least one of the following: introduction information of a job position, introduction information of a company to which the job position belongs. In particular, by including the introduction information of the company, applicants not only have an understanding of the job position, but also have a higher level of understanding of the company to which the job position belongs, which helps the applicants to have a more comprehensive understanding of recruitment information that is currently browsed.

Step 404A: Display a detailed content of the recruitment information in response to a confirmation trigger of the multimedia introduction information implemented by the applicant.

In implementations, since the detailed content of the recruitment information is usually expressed in a textual form, it is not conducive to quickly view by an applicant. The multimedia introduction information is easier to be quickly understood by the applicant than the textual form. Especially true when the applicant needs to face with a large amount of recruitment information, he/she can quickly filter and select recruitment information of interest by viewing the multimedia introduction information, and screen out most of the recruitment information that is not of interest. Furthermore, when a detailed content of recruitment information that is of interest is viewed, the amount of text reading for the applicant is greatly reduced, thus helping to improve the efficiency of viewing of recruitment information by the applicant.

In implementations, when an applicant is interested in any recruitment information, a request may be initiated to the server, so that the server sends an resume of the applicant to a recruiter corresponding to that recruitment information, to allow the recruiter for viewing. A viewing process can refer to the embodiments as shown in FIGS. 2A-2B and 3, which is not repeated herein.

In implementations, if the electronic device of the applicant plays the multimedia introduction information in the recruitment information on a third display interface, the electronic device of the applicant can switch from the third display interface to a display interface for a detailed content of the recruitment information after responding to the confirmation trigger implemented by the applicant on the multimedia introduction information. The applicant can continuously view the multimedia introduction information and the detailed content of the same recruitment information.

In implementations, if the electronic device of the applicant plays the multimedia introduction information in the recruitment information on a third display interface, the electronic device of the applicant can obtain a detailed content of the recruitment information on the one hand, and switch from the third display interface to a fourth display interface of multimedia introduction information of other recruitment information on the other hand, after responding to the confirmation trigger implemented by the applicant on the multimedia introduction information. In other words, the electronic device on user side of the applicant completes an acquisition of the detailed content at the back end, and switches from the third display interface to the fourth display interface that has nothing to do with the detailed content at the front end, so that the applicant can continuously view multimedia introduction information of multiple pieces of recruitment information. Thus, “view multimedia introduction information” and “view detailed content” are divided into two parts for processing. When an applicant wants to view the above detailed content, an electronic device on a user side of the applicant can then switch to a display interface for a detailed content of the recruitment information according to a triggering operation of the applicant on the detailed content of the recruitment information.

In implementations, the electronic device of the applicant can send a verification request to a predefined verification platform, so that the predefined verification platform can verify an identity of the recruiter and/or the company to which the recruiter belongs, which can avoid fake recruiters and companies.

In implementations, the electronic device of the applicant may send a verification request to a verified user of the predefined verification platform, so that the verified user can verify the recruiter and/or the company to which the recruiter belongs. The verified user is an associated user of the recruiter. For example, when an applicant discovers recruitment information sent by a recruiter A of an enterprise AA, a verification request can be sent to a certain user B of the enterprise AA in order to confirm the authenticity of the recruitment information. The user B perform verification on the identity of the recruiter A and the authenticity of recruitment information, etc.

In implementations, when an applicant provides an resume to a recruiter, the server may limit a browsing permission of the recruiter for a detailed content of the resume by default, and allows him/her to view multimedia introduction information, introduction content, etc., in the resume. When the applicant proactively sends a communication message to the recruiter, the server can remove the restriction on the browsing permission, so that the recruiter can fully understand conditions of the applicant. In this way, this ensures that communication statuses between recruiters and applicants that are as equal and balanced as possible are maintained.

In implementations, a client of an instant messaging application may run on the electronic device. In other words, the electronic device is configured as a client device of the instant messaging application, and functions of the instant messaging application are improved to make the client device can be used to implement the recruitment information management solutions such as that shown in FIG. 4A, and therefore, an applicant can quickly view and manage recruitment information based on the client device. A function of managing recruitment information may also be combined with an instant messaging function of the instant messaging application. For example, convenient and efficient communications with recruiters are implemented through the instant messaging function, thus further simplifying a process of job applications, and helping to improve the efficiency of job applications.

FIG. 4B is a flowchart of another method 400B for managing recruitment information based on the exemplary embodiments. As shown in FIG. 4B, the method 400B is applied to an electronic device of an applicant, and may include the following steps:

Step 402B: Play multimedia introduction information included in recruitment information on a screen of a device.

In implementations, recruitment information can be pushed by a server or other users to an electronic device of an applicant, so that the electronic device of the applicant can play multimedia introduction information included in the recruitment information. For example, after the applicant uploads an resume configured thereby, the server can automatically find recruitment information that matches the resume, and recommend the recruitment information to the applicant. For another example, after other users view recruitment information that is suitable for the applicant, the recruitment information can be shared to the applicant.

In implementations, the server may maintain a recruitment platform, which is used to display recruitment information submitted by recruiters. An applicant can browse the recruitment information on the recruitment platform through an electronic device of a user side of the applicant. The electronic device of the user side of the applicant plays multimedia introduction information included in the browsed recruitment information.

In implementations, the multimedia introduction information may include at least one of the following: video information, virtual reality information, augmented reality information, mixed reality information, and mediated reality information, which is not limited in the present disclosure. When the multimedia introduction information is ordinary video information, electronic devices such as mobile phones and PCs with video playing functions can play the multimedia introduction information. When the multimedia introduction information is a type such as virtual reality information, augmented reality information, mixed reality information, or mediated reality information, an electronic device of an applicant needs to have functions of playing and displaying relevant types of multimedia introduction information.

In implementations, the multimedia introduction information may include at least one of the following: introduction information of a job position and introduction information of a company to which the job position belongs. In particular, by including the introduction information of the company, applicants not only have an understanding of the job position, but also have a higher level of understanding of the company to which the job position belongs, which helps the applicants to have a more comprehensive understanding of recruitment information that is currently browsed.

Step 404B: Determine that a request for viewing a detailed content of the recruitment information is detected when a touch sliding operation toward a first direction on the screen of the device is detected.

In implementations, since the detailed content of the recruitment information is usually expressed in a textual form, it is not conducive to quickly viewing by an applicant. The multimedia introduction information is easier to be quickly understood by the applicant than the textual form. Especially true when the applicant needs to face with a large amount of recruitment information, he/she can quickly filter and select recruitment information of interest by viewing the multimedia introduction information, and screen out most of the recruitment information that is not of interest. Furthermore, when check a detailed content of recruitment information that is of interest is viewed, this greatly reduces an amount of text reading of the applicant, and helps improve the efficiency of viewing of recruitment information by the applicant.

In implementations, when an applicant is interested in any recruitment information, a request may be initiated to the server, so that the server sends an resume of the applicant to a recruiter corresponding to that recruitment information, to allow the recruiter for viewing. A viewing process can refer to the embodiments as shown in FIGS. 2A-2B and 3, which is not repeated herein.

In implementations, by implementing a touch sliding operation toward a first direction on the screen of the device, when the applicant can quickly express a request for viewing a detailed content of the recruitment information to which the multimedia introduction information belongs when he/she is interested in the recruitment information accordingly. The touch sliding operation can occur anywhere on the screen of the device, so that the applicant does not need to find and locate an option or a button shown on the screen of the device, thus helping the applicant to efficiently implement the touch sliding operation.

In implementations, in response to the viewing request, the electronic device of the applicant may mark the recruitment information as target recruitment information. Furthermore, the electronic device of the applicant may switch the content played on the screen of the device to multimedia introduction information included in other recruitment information. In other words, the electronic device of the applicant does not need to immediately display a detailed content of the recruitment information that the applicant is interested in. The applicant can continue to view multimedia introduction information of other recruitment information. As such, “view multimedia introduction information” and “view detailed content” are divided into two parts for processing. Therefore, the applicant can continuously view multimedia introduction information in a continuous period of time, and then separately view recruitment information that is marked as target recruitment information. This helps to maintain the continuity of work, and thereby improves the efficiency of processing recruitment information.

In implementations, when a touch sliding operation in a second direction different from the first direction is detected on the screen of the device, the electronic device of the applicant may switch the content played by the screen of the device to multimedia introduction information included in other recruitment information. In other words, the applicant can choose to implement a touch sliding operation toward a first direction or a second direction on the screen of the device according to his/her concern about the recruitment information, so as to quickly express his/her concern about the recruitment information. The touch sliding operation can occur anywhere on the screen of the device, so that the applicant does not need to find and locate an option or a button shown on the screen of the device, thus helping the applicant to efficiently implement a touch sliding operation.

In implementations, the electronic device of the applicant may mark the recruitment information as irrelevant recruitment information in response to detecting a touch sliding operation toward a second direction. Whether it is target recruitment information or irrelevant recruitment information, it is actually equivalent to adding a specific mark to corresponding recruitment information. This makes it easier for the applicant to find relevant recruitment information afterwards on the one hand, and can provide reference to the server on the other hand. In this way, when recruitment information is recommended to the applicant in the future, irrelevant recruitment information can be ignored, other recruitment information similar to irrelevant recruitment information can be ignored or reduced, and other recruitment information similar to the target recruitment information can be added or preferentially selected.

In implementations, the electronic device of the applicant can send a verification request to a predefined verification platform, so that the predefined verification platform can verify an identity of the recruiter and/or a company to which the recruiter belongs, which can avoid fake recruiters and companies.

In implementations, the electronic device of the applicant may send a verification request to a verified user of the predefined verification platform, so that the verified user can verify the recruiter and/or the company to which the recruiter belongs. The verified user is an associated user of the recruiter. For example, when the applicant discovers recruitment information sent by a recruiter A of an enterprise AA, in order to confirm the authenticity of the recruitment information, a verification request can be sent to a certain user B of the enterprise AA. The user B verifies the identity of the recruiter A and the authenticity of the recruitment information.

In implementations, when an applicant provides an resume to a recruiter, the server may limit a browsing permission of the recruiter for a detailed content of the resume by default, and allows him/her to view multimedia introduction information, introduction content, etc., in the resume. When the applicant proactively sends a communication message to the recruiter, the server can remove the restriction on the browsing permission, so that the recruiter can fully understand conditions of the applicant. In this way, this ensures that communication statuses between recruiters and applicants that are as equal and balanced as possible are maintained.

In implementations, a client of an instant messaging application may run on the electronic device. In other words, the electronic device is configured as a client device of the instant messaging application, and functions of the instant messaging application are improved to make the client device can be used to implement the recruitment information management solutions such as that shown in FIG. 4A. Therefore, an applicant can quickly view and manage recruitment information based on the client device. A function of managing recruitment information may also be combined with an instant messaging function of the instant messaging application. For example, convenient and efficient communications with recruiters are implemented through the instant messaging function, thus further simplifying a process of job applications, and helping to improve the efficiency of job applications.

In order to facilitate understanding, the technical solutions of the present disclosure are described using an enterprise instant messaging application as an example. If an instant messaging server end run on the server 102, a user A is a recruiter of an enterprise AA, the mobile phone 106 used by the user A is configured as an instant messaging client end 1, a user B is a fresh graduate of a school BB, and the mobile phone 108 used by the user B is configured as an instant messaging client end 2. The user A and the user B can complete recruitment and job application in the enterprise instant messaging application based on the technical solutions in the present disclosure.

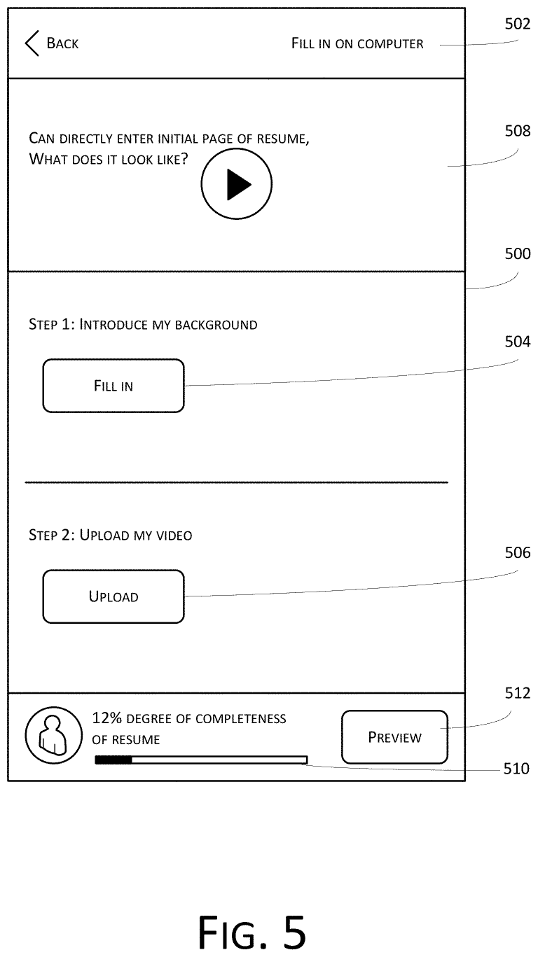

FIG. 5 is a schematic diagram of a filling guidance interface 500 for an resume provided by the exemplary embodiments. The instant messaging client end 2 can present the user B with a filling guidance interface 500 as shown in FIG. 5 to guide the user B to complete a creation or improvement of a corresponding employment resume. In implementations, the filling guidance interface 500 may include a collaborative filling option 502, so that the user B can trigger the collaborative filling option 502 to switch to an instant messaging client end 3 on a PC when determining that it is not convenient to perform filling operations on the mobile phone 108, or for other reasons. The instant messaging client end 3 is logged in with a registered account of the user B, which is actually equivalent to the “instant messaging client end 2” running on the PC.

An example that the user B completes filling through the instant messaging client end 2 is used. The filling guidance interface 500 can guide the user B to fill in various aspects of information. For example, the background information of the user B can be filled in by triggering a filling option 504, and an introduction video of the user B can be uploaded by triggering an upload option 506. If the user B has not created an resume using an instant messaging application, he/she can also view a guide video 508 provided in the filling guidance interface 500 to understand a creation process, items to be noted, etc. for a creation of a job application. The filling guidance interface 500 can also inform the user B of a degree of completeness of an resume thereof through a text “12% of degree of completeness of resume” and a progress bar 510, etc. The corresponding resume can be previewed by triggering a preview option 512 to understand a creation progress of the resume and other information. Since the user B has already filled in some information in the registered account of the instant messaging application, the instant messaging application can automatically fill this part of information into an resume of the user B without the need of the user B to fill that in again, though the user B in FIG. 5 has not started to create a resume. Apparently, the user B can edit and change contents that are automatically filled to update the contents.

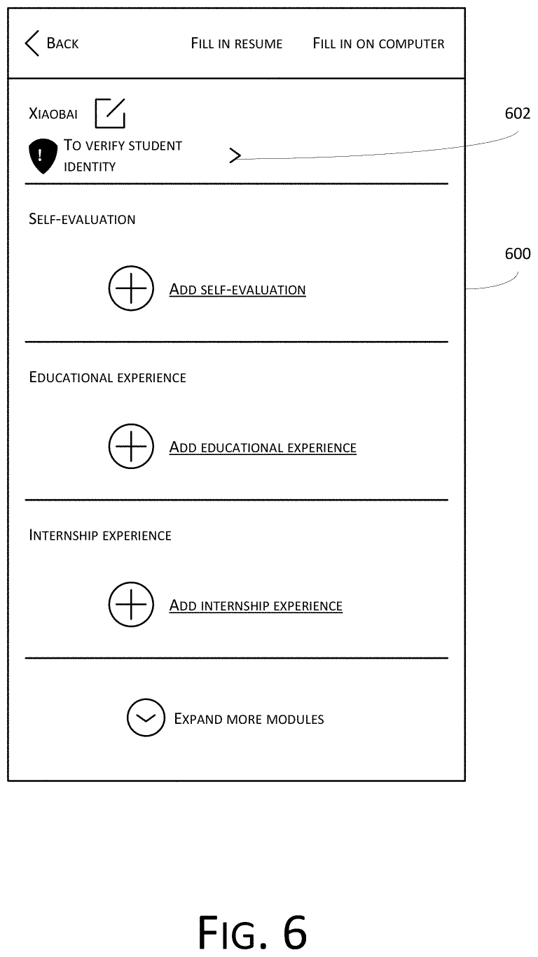

FIG. 6 is a schematic diagram of a background information filling interface 600 provided by the exemplary embodiments. In response to the user B's triggering operation of the filling option 504 mentioned above, the instant messaging client end 2 can switch to a background information filling interface 600 as shown in FIG. 6 to fill in a number of dimensions of background information, such as “self-evaluation”, “educational experience”, and “internship experience”, etc., of the user B. More dimensions of background information can also be filled in by triggering “Expand more modules”, and desired dimensions of background information can even be customized.

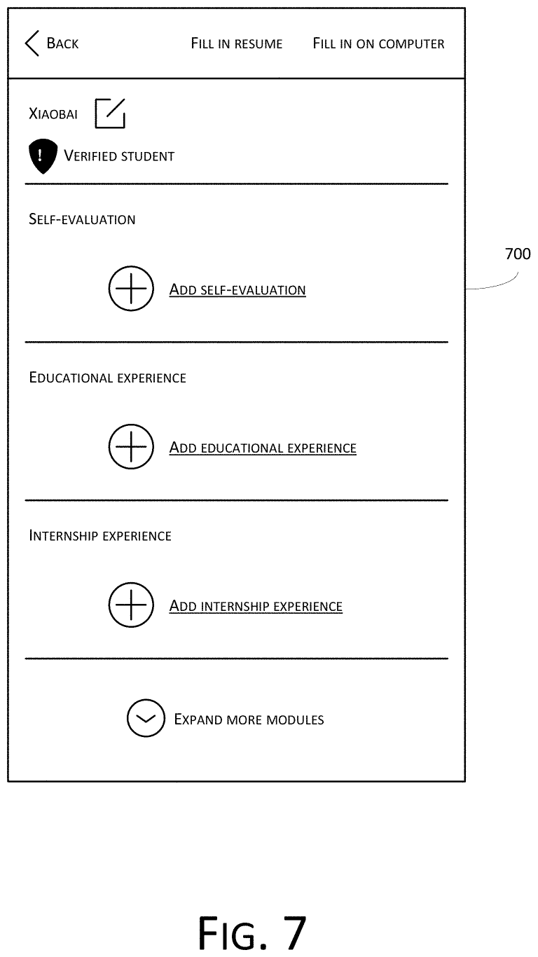

The name of the user B is assumed to be “Xiaobai” as shown in FIG. 6. When the user B is a student of a school BB, he/she can complete an authentication of his/her student identity by triggering an authentication option 602 shown in FIG. 6. A recruiter can determine that the user B is indeed a student of the school BB based thereon. Apparently, if the user B is not a student of the school BB (a current student of another school, or has graduated from the school BB), the identity authentication cannot be successfully completed. After the authentication of the student identity is completed, “verified student” or other marked content in an interface 700 as shown in FIG. 7 can be displayed in the resume of the user B, and detailed authentication information can be viewed by triggering the marked content.

In implementations, the user B can perform the authentication of the student identity on a predefined trust management platform, and give authorization to the instant messaging application after the authentication is successful, so that the instant messaging application can complete the identity authentication of the user B based on an authentication result of the trust management platform. In another embodiment, the instant messaging application itself may have an identity authentication function. In this case, the user B can directly complete the identity authentication on the instant messaging client end 2 without the need of performing end-to-end authorization with other platforms. In another embodiment, an interactive authentication method can be used. For example, when the user B declares as a student of a school BB, he can initiate an authentication request to a staff, teacher, or student of the school BB who has passed the identity authentication. These users can authenticate the student identity of the user B. Authentication can also be performed in other ways, which will are not exhaustively listed herein, and the present disclosure does not have any limitations thereon.

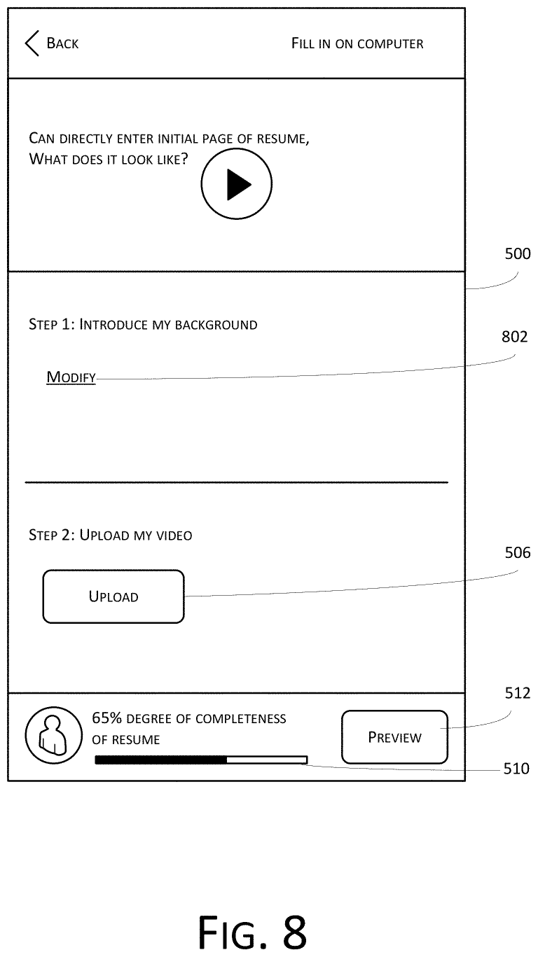

FIG. 8 is a schematic diagram of another example guidance interface for filling in an resume provided by the exemplary embodiments. After the user B completes the background information, the filling option 504 in FIG. 5 changes to a modification option 802 shown in FIG. 8. On the one hand, this type of difference in displaying can be used to remind the user B that the background information has been filled in. On the one hand, the user B can modify or improve the background information that has been filled in by triggering the modification option 802. At the same time, prompt information about a degree of completeness of the resume in the guidance interface 500 is also changed. For example, the text content changes to “65% of degree of completeness of resume”, and the progress bar 510 also changes accordingly.

In implementations, the user B can modify or improve the background information that has been filled in by triggering the modification option 802, or by triggering the upload option 506 to upload the user B's own introduction video, so that a recruiter can have a quick understanding of the user B. Methods of uploading a video can refer to solutions in the related technologies, such as uploading a video captured at a current moment or uploading of a video that has been captured from a video library, etc., which are not limited by the present disclosure. The instant messaging application can set certain requirements for a definition, a file size, a file format, and a number of videos for an introduction video, and can assist the user B to upload the introduction video that meets the requirements.

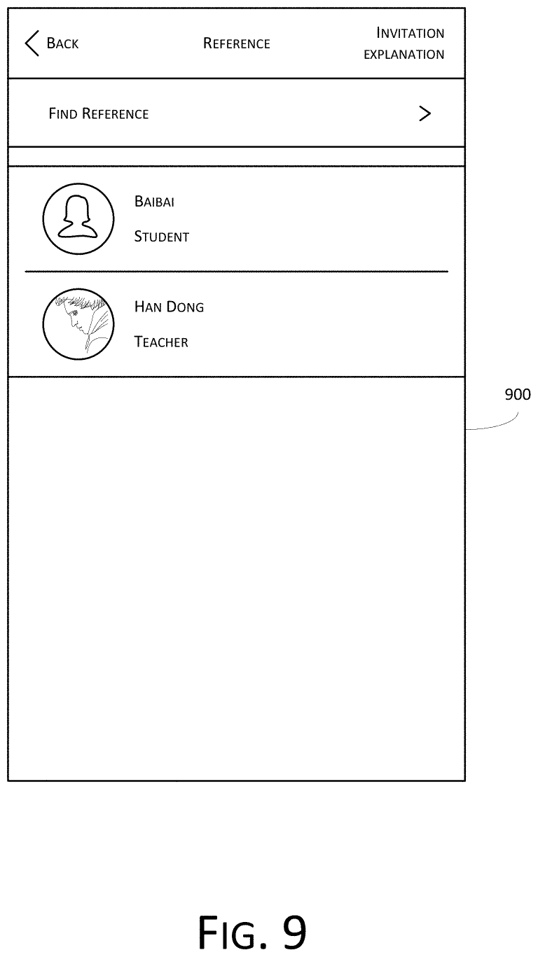

FIG. 9 is a schematic diagram of an example reference setting interface 900 provided by the exemplary embodiments. As shown in FIG. 9, the user B can set one or more references through a reference setting interface 900, such as a classmate “Baibai” and a tutor “Han Dong”, etc., of the user B, and can also use “Find reference” to set more references. The reference can be an industry elite with a certain degree of credibility, etc., so that a recruiter can obtain more dimensional information based on an endorsement of the reference on a basis of understanding the user B through the resume.

In implementations, a reference may only express “support” in a broad sense to the user B. In another embodiment, a reference can provide detailed reasons of recommendation for the user B, and introduce the learning ability, the character attitude, the internship experience, etc., of the user B, so as to make the recommendation for the user B to be more detailed and more persuasive. The user B may have no permission for editing the reasons of recommendation provided by the reference to ensure that the reasons of recommendation are true and reliable.

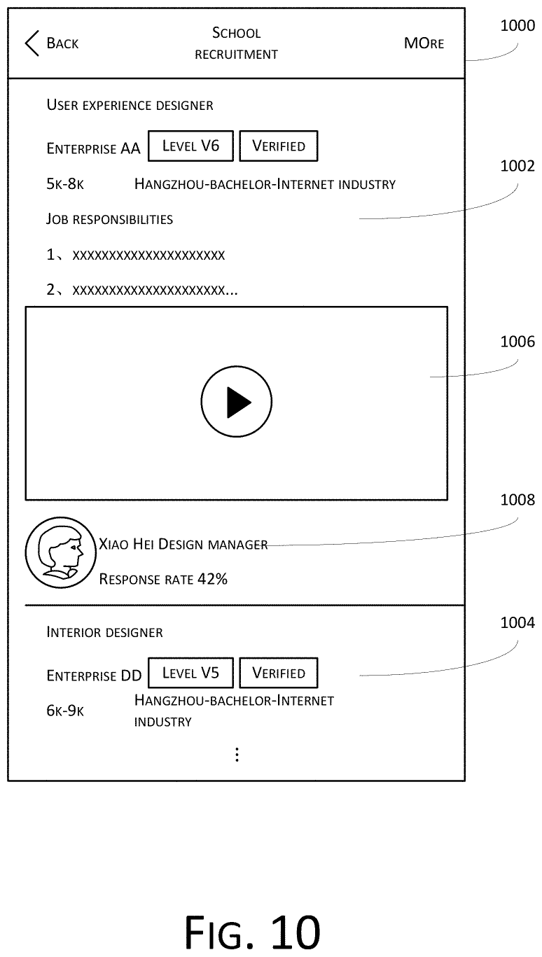

FIG. 10 is a schematic diagram of an example recruitment information display interface 1000 provided by the exemplary embodiments. The user A can publish recruitment information through the instant messaging client end 1, and other users can also publish recruitment information through corresponding instant messaging client ends respectively. Correspondingly, the instant messaging client end 2 can present a recruitment information display interface 1000 as shown in FIG. 10 to the user B for displaying the recruitment information published by the user A or the other users. For example, the recruitment information display interface 1000 includes recruitment information 1002, recruitment information 1004, etc.

In implementations, the instant messaging client end 2 can display all the published recruitment information in the recruitment information display interface 1000, and the user B can manually view or filter the recruitment information. In another embodiment, for the introduction information or the created resume of the user B in the instant messaging application, the instant messaging server end can search the published recruitment information to match the user B (i.e., the aforementioned introduction information and/or resume), and recommend the found recruitment information to the user B. The user B will view this information in the recruitment information display interface 1000. In yet another embodiment, when a friend, classmate, or another associated user of the user B sees recruitment information that is suitable for the user B, the recruitment information can be shared with the user B, and user B can view the information in the recruitment information display interface 1000. Similarly, when the user B finds recruitment information that may be of interest to other users, he/she can also share the recruitment information with the other users.

In implementations, recruitment information 1002 is assumed to be released by the user A through the instant messaging client end 1. The recruitment information 1002 may include introduction information, such as a job title “User Experience Designer”, a company “Enterprise AA”, company information “Level V6” and “Verified”, a salary level “5 k-8 k”, etc., as shown in FIG. 10, to allow the user B to understand the recruitment position and the company to which it belongs. At the same time, the recruitment information 1002 may also include a video portal 1006, which is used to trigger a playing of an introduction video, so as to introduce the recruitment position and/or the company's information corresponding to the recruitment information 1002 to the user B in a more vivid and visual way. And, the recruitment information 1002 may also include publisher information 1008. For example, when the recruitment information 1002 is published by the user A, the publisher information 1008 may include information of the user A such as a name “Xiao Hei”, a position “design supervisor”, and a response rate “42%”, etc.

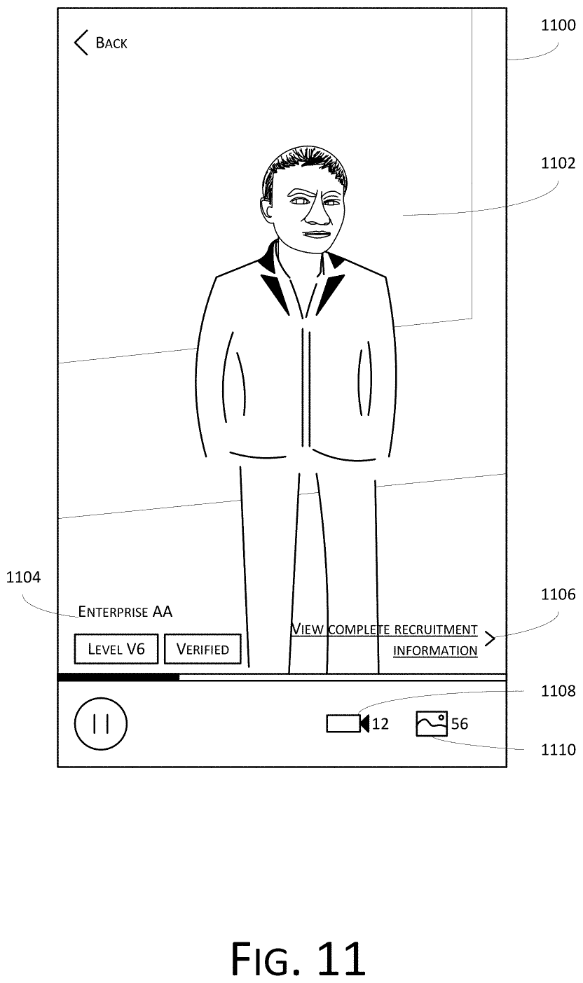

In implementations, in response to detecting a triggering operation of the video portal 1006 by the user B, the instant messaging client end 2 may switch to an enterprise introduction video playing interface 1100 as shown in FIG. 11 to play the introduction video. The enterprise introduction video playing interface 1100 may include a video playing area 1102 used for playing the above introduction video. The introduction video can introduce the job information corresponding to the recruitment information 1002, and can also introduce the enterprise AA. The position information and the enterprise AA can also be introduced at the same time. The present disclosure does not have any limitation thereon. The number of introduction videos can be multiple, and the user B can select and view an introduction video of interest by triggering a video selection option 1108. In addition, the user B can also view introduction picture(s) related to the recruitment information 1002 by triggering a picture selection option 1110. The introduction picture(s) can introduce the job information corresponding to the recruitment information 1002, or can introduce the enterprise AA, or can introduce the job information and the enterprise AA at the same time. The present disclosure does not have any limitation thereon. The enterprise introduction video playing interface 1100 may also include enterprise introduction information 1104, for example, a company name which is “Enterprise AA”, and the company information which includes “Level V6” and “Verified” to help the user B understand the enterprise AA.

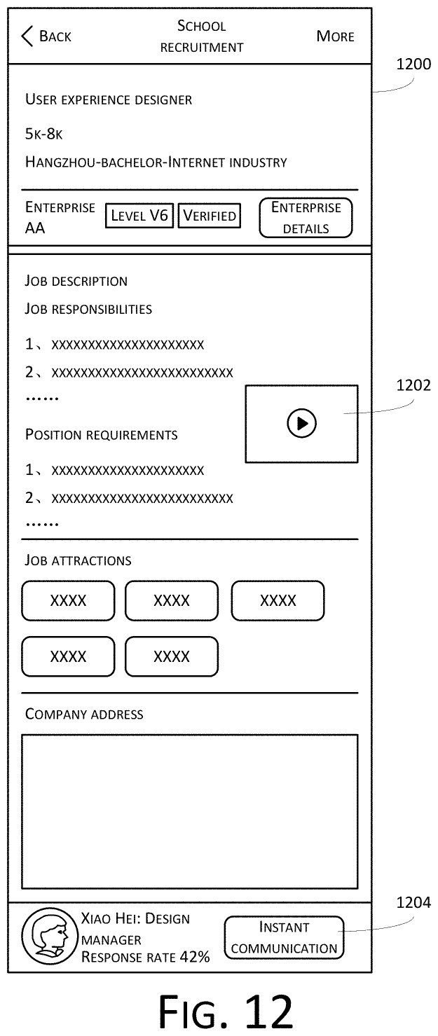

In implementations, the enterprise introduction video playing interface 1100 may include a complete recruitment information viewing option 1106 as shown in FIG. 11. When the user B is interested in the details of the recruitment information 1002 after watching the introduction video and other content, he/she can trigger the complete recruitment information viewing option 1106, so that the instant messaging client end 2 switches and enters into a complete recruitment information display interface 1200 as shown in FIG. 12 to display a detailed content of the recruitment information 1002. The complete recruitment information display interface 1200 may not only display the detailed content of the recruitment information 1002, but also include a video portal 1202, so that the user B can trigger the video portal 1202 to return to the enterprise introduction video playing interface 1100 as shown in FIG. 11. The video portal 1202 may only have a portal function, or the video portal 1202 may also serve as a thumbnail window of the enterprise introduction video playing interface 1100, so that the user B can still view the introduction video when browsing the complete recruitment information display interface 1200.

In implementations, the user B can first switch to the enterprise introduction video playing interface 1100 as shown in FIG. 11 by triggering the video portal 1006 shown in FIG. 10, and then switch to the recruitment information display interface 1200 as shown in FIG. 12 by triggering the complete recruitment information viewing option 1106. In another embodiment, the user B can directly switch to the complete recruitment information display interface 1200 shown in FIG. 12 by triggering the recruitment information 1002 shown in FIG. 10, and does not necessarily need to view the introduction video. The present disclosure does not have any limitation thereon.

In implementations, the complete recruitment information display interface 1200 may include a communication option 1204 as shown in FIG. 12, so that the user B can immediately communicate with the user A that posts the recruitment information 1002, after triggering the communication option 1204, thus improving the efficiency of job application.

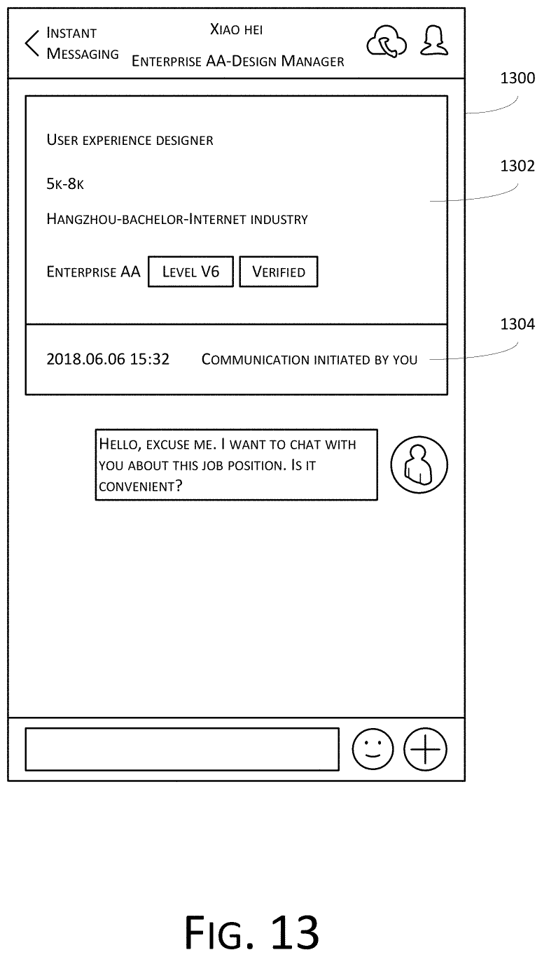

FIG. 13 is a schematic diagram of an example communication interface 1300 of an applicant provided by the exemplary embodiments. In response to the triggering operation of the aforementioned communication option 1204 by the user B, the instant messaging client end 2 can switch to the communication interface 1300 as shown in FIG. 13, and communicate with the user A through the communication interface 1300. Since the communication option 1204 is related to the recruitment information 1002, the communication interface 1300 may show the introduction information 1302 corresponding to the recruitment information 1002 and creation information 1304 of a current communication event, for example, a time of creation being 15:32 on Jun. 6, 2018, a creator being the user B, etc. In this case, especially when the user B communicates with multiple recruiters at the same time, or communications are not continuous due to some reasons, a communication reminder to the user B can be realized through the introduction information 1302 and the creation information 1304, thus enabling a quick determination of a topic that is currently discussed.

In implementations, when the user B actively sends a communication message to the user A, this indicates that user B is likely to be interested in the recruitment information posted by the user A. Therefore, the instant messaging server end can actively send the resume of the user B to the user A for view by user A. Apparently, when the user B wants to send a communication message, the instant messaging client end 2 can display prompt information to the user B, so that the user B can determine whether a communication message needs to be sent or whether he/she wants to keep the job application information as confidential and terminate the communication message.

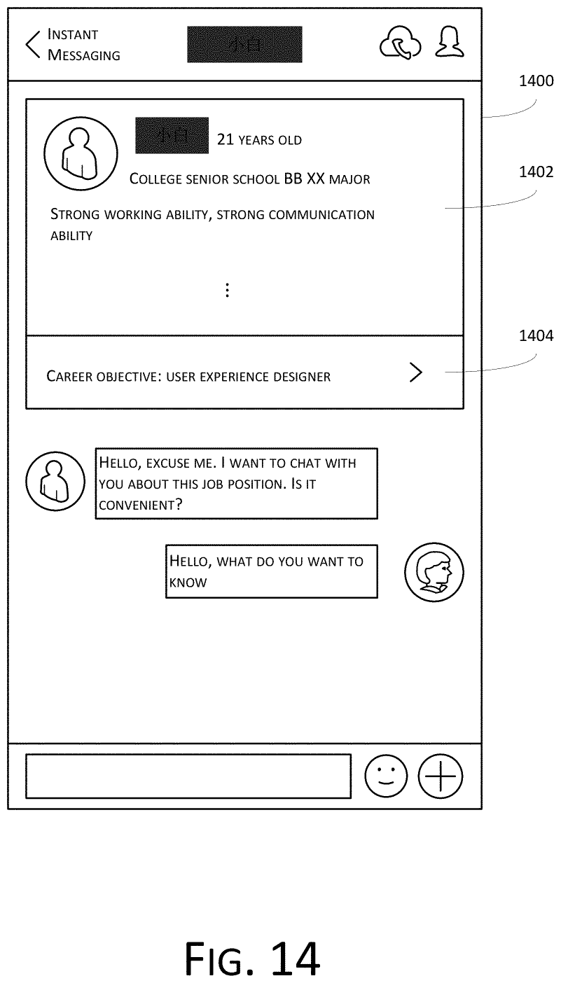

FIG. 14 is a schematic diagram of an example communication interface 1400 of a recruiter provided by the exemplary embodiments. As shown in FIG. 14, the instant messaging client end 1 can present a communication interface 1400 to the user A. The communication interface 1400 includes a communication message “Hello, excuse me. I want to chat with you about this job position. Is it convenient?” that is sent by the user B in the above communication interface 1300, and a communication message “Hello, what do you want to know?” returned by the user A. The communication interface 1400 may include introduction information 1402 of the resume of the user B, so that the user A can quickly understand conditions of the user B. The communication interface 1400 may also include introduction information 1404 corresponding to the recruitment information 1002, etc., so that the user A can quickly understand the job position in the current communication. When the user A publishes too much recruitment information and cannot recall conditions of the recruitment information 1002 in time, the user A can trigger the introduction information 1404 to enable the instant messaging client end 1 to display the detailed content of the recruitment information 1002.

In implementations, the user A does not have a browsing permission for resume content such as a name, contact information, etc., of the user B by default. For example, the name of the user B is processed and displayed in mosaic in FIG. 14 (i.e., the black rectangular block as shown in FIG. 14) to achieve the confidentiality of information.

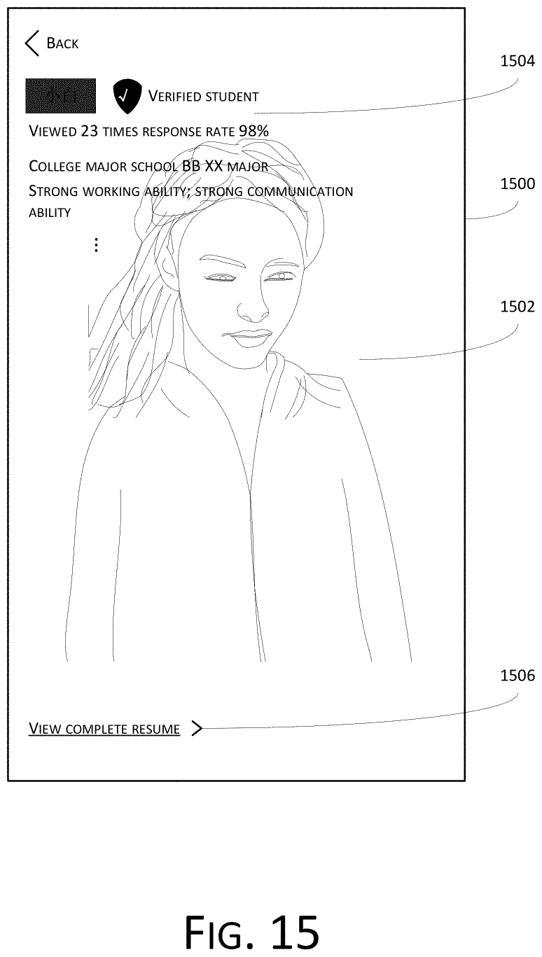

In implementations, in addition to the introduction information 1402 such as “21 years old”, “college senior”, “school BB”, “XX major”, “strong working ability”, and “strong communication ability”, etc., as shown in FIG. 14, the user A can also view the introduction video in the resume of the user B. For example, FIG. 15 is a schematic diagram of an example applicant introduction video playing interface provided by the exemplary embodiments. In response to a triggering operation on the introduction information 1402 by the user A, the instant messaging client end 1 can switch to the applicant introduction video playing interface 1500 as shown in FIG. 15, and plays the introduction video that is added to the resume by the user B. In implementations, the applicant introduction video playing interface 1500 may include a video playing area 1502 used for playing the introduction video that is added to the resume by the user B. The applicant introduction video playing interface 1500 may also include introduction information 1504, which is basically the same as the above-mentioned introduction information 1402, and may have some differences in content. For example, the introduction information 1504 may include an authentication result of the student identity of the user B in FIGS. 6-7, etc.

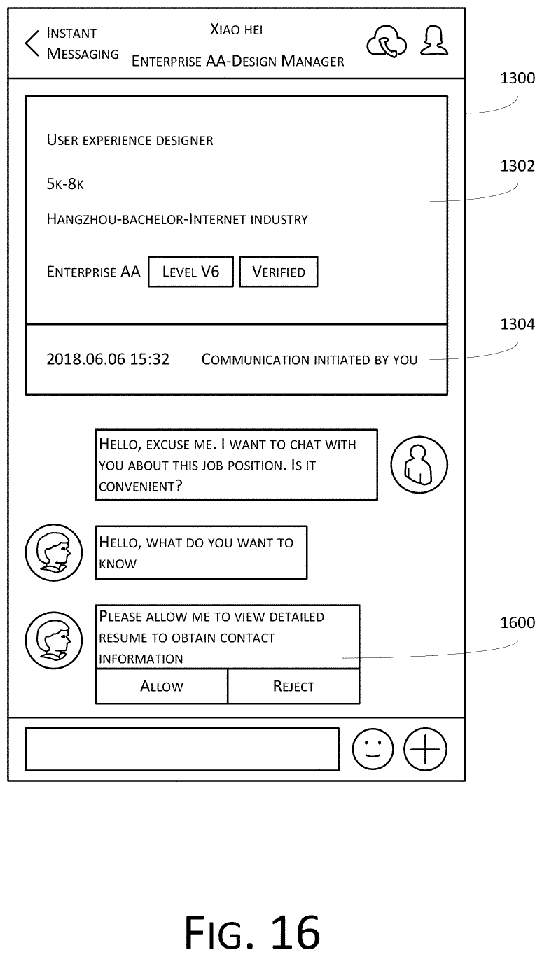

In implementations, by viewing the introduction video of the user B, the user A can quickly learn more information that is related to the user B, thereby determining whether the user B is considered to be suitable for the job position corresponding to the recruitment information 1002. When the user A believes that the user B may be suitable for the job position, a triggering operation can be implemented on a view complete resume option 1506 shown in FIG. 15, such as clicking the view complete resume option 1506. In response to the triggering operation on the view complete resume option 1506 by the user A, the instant messaging client end 1 can (via the instant messaging server end) initiate a complete resume view request to the instant messaging client end 2, so that the instant messaging client end 2 can present a selection window 1600 as shown in FIG. 16 to the user B, for the user B to determine whether to allow the user A to view the entire content of his/her resume.

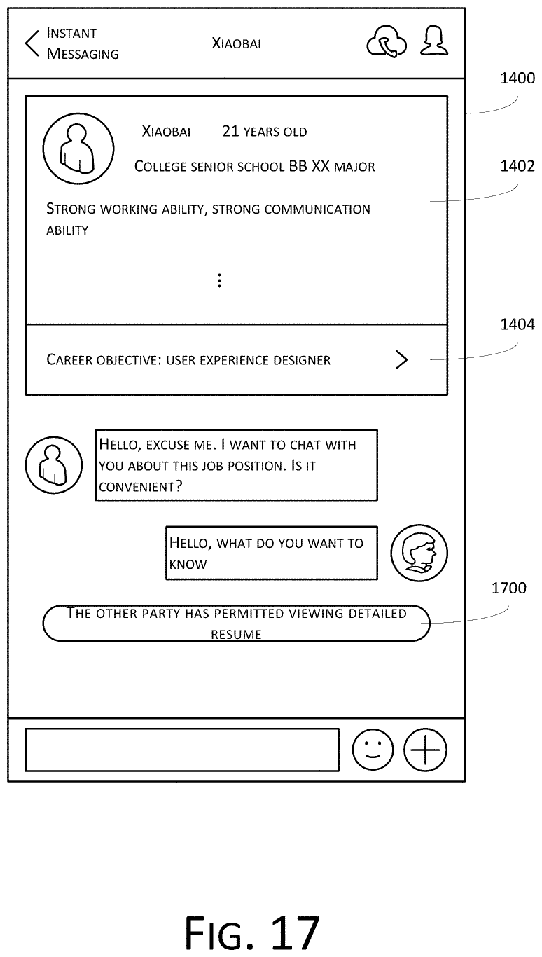

When the user B selects a permission option as shown in FIG. 16, this indicates that the user B allows the user A to view the entire content of his/her resume, and the instant messaging client end 2 can return a confirmation message to the instant messaging client end 1 (via the instant messaging server end). On the one hand, the instant messaging client 1 can present prompt message 1700 as shown in FIG. 17. For example, the content of the prompt message 1700 is “The other party has allowed the detailed resume to be viewed.” A corresponding permission is granted to the user A, so that the user A can view the entire content of the resume of the user B.

In implementations, after the user A obtains the above permission, the communication interface 1400 displayed by the instant messaging client end 1 can cancel the mosaic processing of the name of the user B, and thus display the name “Xiaobai” as shown in FIG. 17.

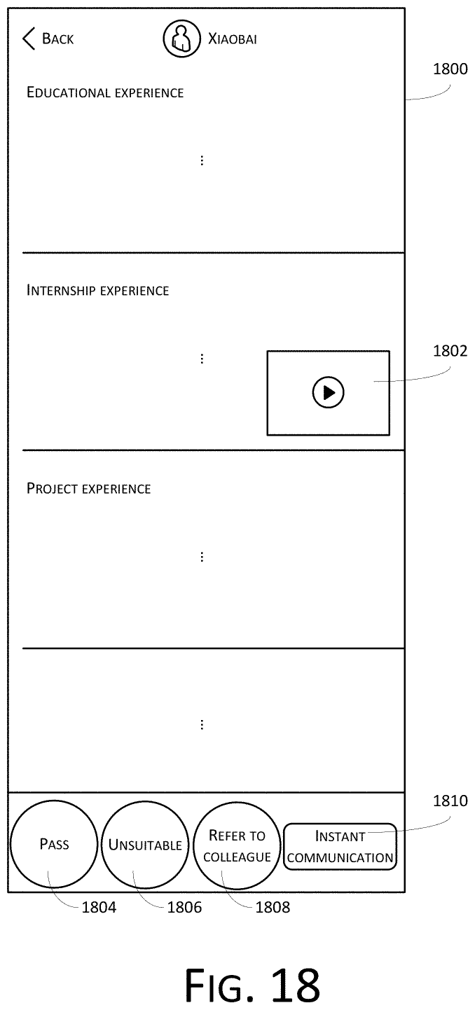

In implementations, when the user A triggers the introduction information 1402, the instant messaging client end 1 can switch to an resume display interface 1800 as shown in FIG. 18 to display the complete content of the resume of the user B. The resume display interface 1800 may include textual description information of the user B, background information corresponding to user B filled in FIG. 6, etc., and may also include a video portal 1802. The video portal 1802 can be used to switch to the applicant introduction video playing interface 1500 as shown in FIG. 15, to play the introduction video uploaded by the user B in FIG. 6.

In implementations, when the user A triggers the introduction information 1402, the instant messaging client end 1 can switch to the applicant introduction video playing interface 1500 as shown in FIG. 15. When the user A triggers the view complete resume option 1506, the enterprise The WeChat client end 1 can switch to the resume display interface 1800 as shown in FIG. 18.

In implementations, the resume display interface 1800 may include a confirmation option 1804 and a rejection option 1806. The user A can trigger the confirmation option 1804 to set the user B as a candidate for the job position corresponding to the recruitment information 1002, or trigger the rejection option 1806 to exclude the user B. The resume display interface 1800 may also include a sharing option 1808. When the user A thinks that the user B is more suitable for a job position that another user C needs to recruit, he/she can push the resume of the user B to the user C through this sharing option 1808, to allow the user C to communicate with the user B.

In implementations, the resume display interface 1800 may include a communication option 1810. When the user A has communicated with the user B, the user A can quickly switch the display interface of the instant messaging client end 1 to the communication interface 1400 as shown in FIG. 17, by triggering the communication option 1810.

Similar to sharing the resume of the user B with the user C by the user A, the user A can also receive resumes shared by other users, and view and filter the resumes. The user A can only view introduction information and introduction videos in the resumes by default, and needs to initiate a request to an applicant to obtain a permission to view a complete content. This is similar to the process of requesting permission in the above embodiments, and is not repeated herein.

In addition, according to the recruitment information published by the user A, the instant messaging server end can automatically find resume(s) that match(es) the recruitment information, and actively push the resume(s) to the user A. The user A can them process the resume(s) in a similar manner to the above embodiments, which is not repeated herein. Alternatively, the instant messaging application can also provide a resume search function. The user A can set filtering conditions through the instant messaging client end 1, and matching is performed on resumes that are obtained from the instant messaging server end (all resumes created by applicants are persisted in the enterprise The WeChat server end), thereby to filter and select matching resumes. In this case, the user A can perform processing in a similar manner to the above-mentioned embodiments, which is not repeated herein.

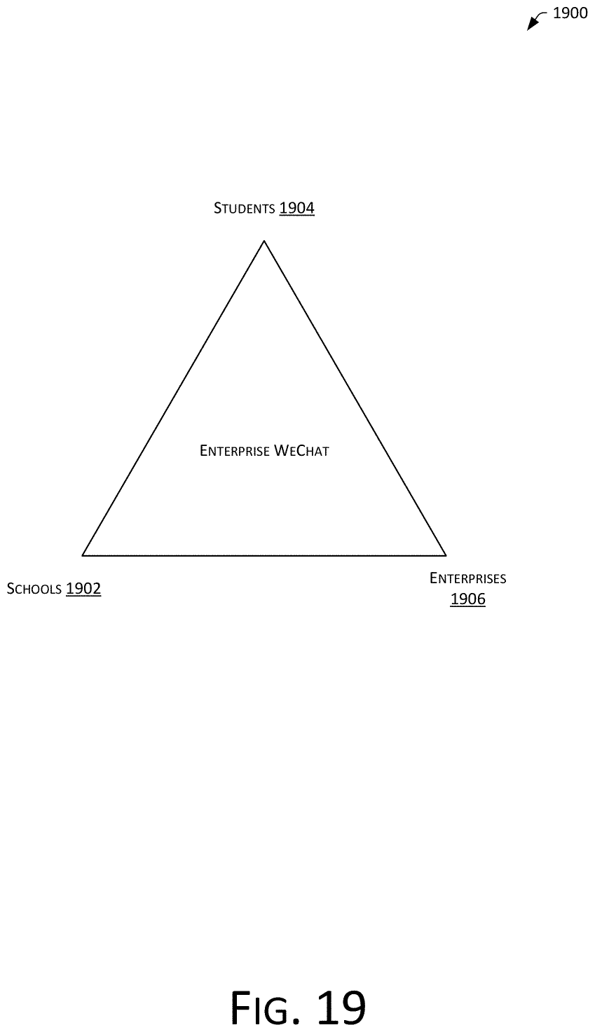

FIG. 19 is a schematic diagram of an example multi-party relationship 1900 in an instant messaging application involved under a school recruitment scenario provided by the exemplary embodiments. As shown in FIG. 19, in the school recruitment scenario, the instant messaging application not only needs to coordinate relationships between students and enterprises (for example, providing recruitment information published by personnel in enterprises such as the user A to students such as the user B for viewing, and providing resumes configured by students such as the student B to publishers of recruitment information such as the user A, etc.), but also involves tripartite relationship between the students' schools 1902, the students 1904 and the enterprises 1906. In the tripartite relationships, the technical solutions in the present disclosure implemented through the instant messaging application can provide benefits to the enterprises, the students and the schools.

From the perspective of an enterprise, by publishing recruitment information configured by the enterprise on a recruitment platform, or pushing recruitment information to applicants such as appropriate students, the instant messaging application can realize a rapid release and efficient distribution of recruitment information. For example, by marking labels such as “Level V6”, “Verified” in the recruitment information as shown in FIG. 10, true conditions of a relevant enterprise can be easily restored, so that applicants such as students can accurately and quickly understand a degree of reliability of the enterprise. For another example, by including an introduction video in recruitment information, especially an introduction video for an overall situation of an enterprise, an applicant such as a student can not only understand a job position he/she is applying for, but also fully understand conditions of the enterprise to which the job position belongs. In this way, a dissemination of corporate brand and corporate culture can be realized in more dimensions, and a more intuitive experience of job applications is brought to applicants such as students.

From the perspective of a student, as compared with the pure textual resume in the related technologies, the instant messaging application can achieve a more vivid and lively resume format through an introduction video included in an resume that is uploaded by the student, and can quickly and vividly present the student's characteristics, advantages, etc. to recruiters and users, which helps to increase the probability of success of job applications by the student. At the same time, since the release and viewing of recruitment information, the delivery and screening of resumes, and the communications between recruiters and applicants can all be completed online through the instant messaging application, the efficiencies of recruitment and job application are greatly improved.

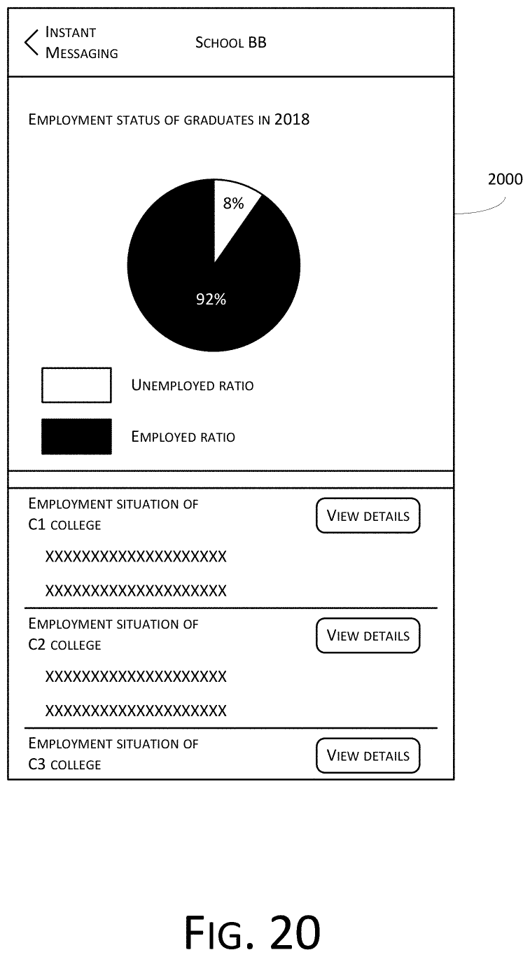

From the perspective of a school, the instant messaging application can automatically complete employment statistics of each school according to the recruitment of students by each enterprise, without the school's manual implementation of statistical operations, which can liberate the work pressure of the school staff, improve work efficiency and the accuracy of statistical results. For example, FIG. 20 is a schematic diagram of an example employment statistics display interface 2000 provided by the exemplary embodiments. By running an instant messaging client end on an electronic device and logging in a school account on the instant messaging client end, the electronic device can display an employment statistics display interface 2000 as shown in FIG. 20 to a school staff. The employment statistics display interface 2000 includes employment statistics of corresponding school(s).

In implementations, the employment statistics display interface 2000 may include “employment status of graduates in 2018” presented in a form of a pie chart. For example, the employed ratio is 92% and the unemployed ratio is 8%. In implementations, the employment statistics display interface 2000 can separately display an employment situation of each college, such as C1 College, C2 College, and C3 College. The school staff can trigger a “View Details” option corresponding to any college, enabling the instant messaging client end to display data of employment details of the any college.

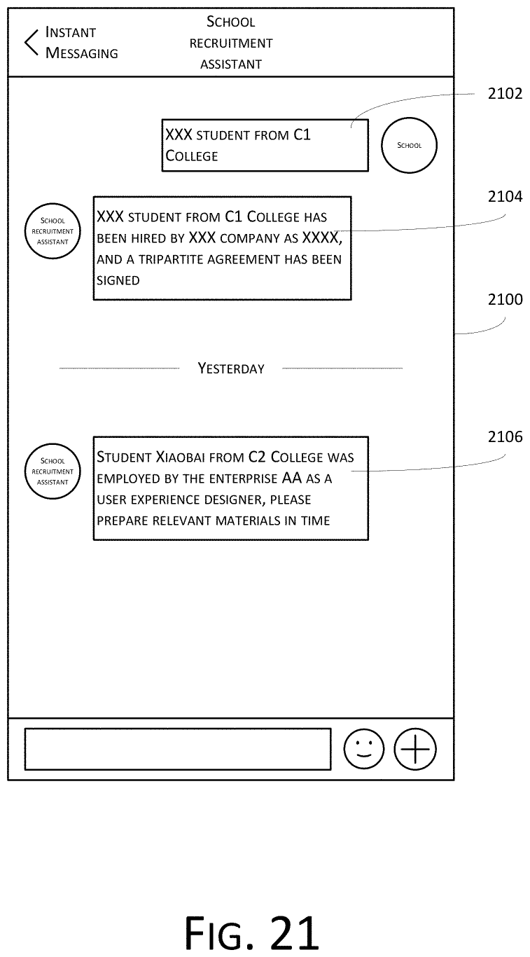

FIG. 21 is a schematic diagram of an example school recruitment assistant interface 2100 provided by the exemplary embodiments. An instant messaging client end can provide a school staff with a school recruitment assistant interface 2100 as shown in FIG. 21, so that the school staff can obtain assistance related to school recruitment statistics.

For example, the school staff can enter an inquiry message 2102 on the school recruitment assistant interface 2100, so that the instant messaging server end can perform corresponding data inquiry or statistical processing according to the inquiry message 2102, and return a corresponding inquiry result 2104. For example, when the content of the inquiry message 2102 is “XXX student from C1 College”, this indicates that the school staff may want to inquire about job hiring progresses of students, then the inquiry result 2104 can be “XXX student from C1 College has been hired by XXX company as XXXX, and a tripartite agreement has been signed”, indicating that job hiring has been completed.

For another example, when a WeChat server end of an enterprise can find out the school recruitment data related to the above-mentioned school in time through hiring situations of each applicant by each enterprise, and push it to the relevant school staff. For example, when the user B in the above embodiments is employed by the enterprise AA, the instant messaging server end can push a corresponding notification message 2106 to the school account. The notification message 2106 can be “Student Xiaobai from C2 College was employed by the enterprise AA as a user experience designer, please prepare relevant materials in time”. On the one hand, the school staff is informed of an application progress of the user B, and the school staff is reminded to prepare relevant materials for the user B and assist him/her in completing the follow-up work on the other hand.

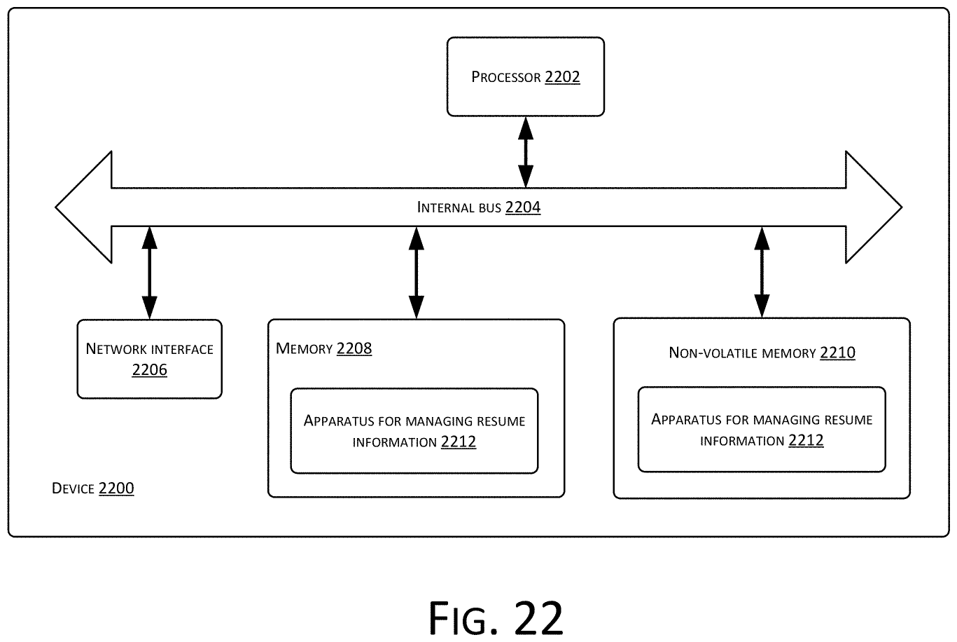

FIG. 22 is a schematic structural diagram of an example device 2200 according to the exemplary embodiments. Referring to FIG. 22, at a hardware level, the device includes a processor 2202, an internal bus 2204, a network interface 2206, a memory 2208, and a non-volatile memory 2210, and apparently may also include hardware needed by other services. The processor 2202 reads and runs a corresponding computer program from the non-volatile memory 2210 to the memory 2208 to form an apparatus 2212 for managing resume information on a logical level. Apparently, the present disclosure does not exclude other implementations, such as logic devices or a combination of software and hardware, etc. This means that an execution body of the following flow of processing is not limited to various logic units, and can also be hardware or logic devices.

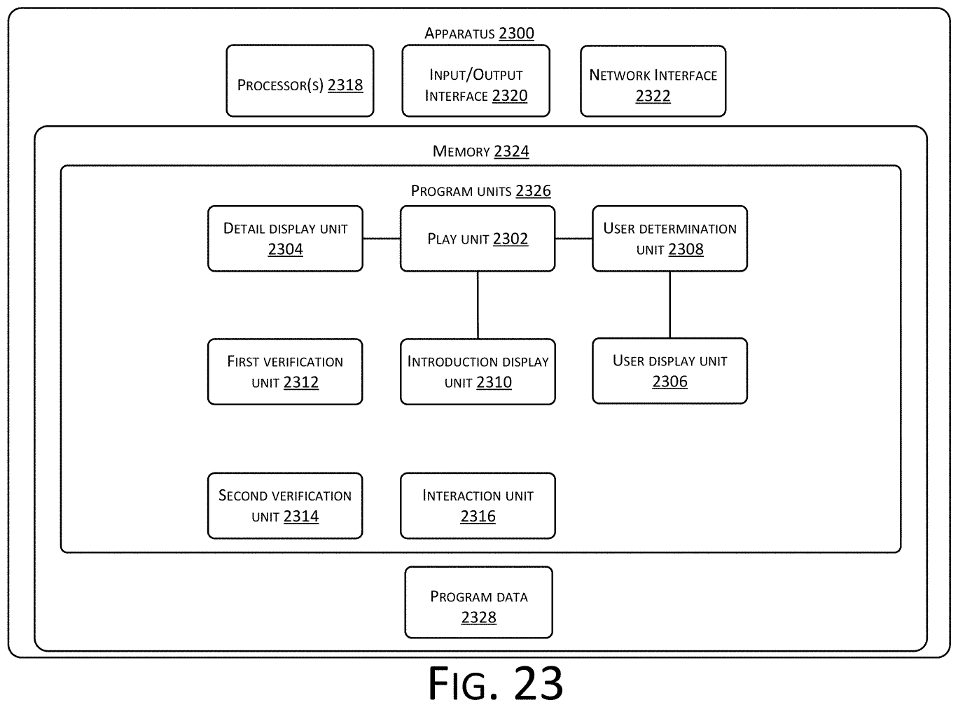

Referring to FIG. 23, in implementations, an apparatus 2300 for managing resume information may include:
a play unit 2302 that plays multimedia introduction information included in an resume of an applicant; and
a detail display unit 2304 that displays a detailed content of the resume in response to a confirmation trigger implemented by a recruiter on the multimedia introduction information.

In implementations, the multimedia introduction information includes at least one of the following: video information, virtual reality information, augmented reality information, mixed reality information, and mediated reality information.

In implementations, the detail display unit 2304 may be configured to:
send a detailed content view request to the applicant in response to the confirmation trigger implemented by the recruiter on the multimedia introduction information; and
obtain a browsing permission for a detailed content of the resume, and display the detailed content of the resume, according to a confirmation response of the applicant for the detailed content view request.

In implementations, the detailed content of the resume includes: contact information of the applicant.

In implementations, the apparatus is applied in a client device of an instant messaging application, and the detailed content view request is sent to the applicant based on the instant messaging application.

In implementations, the detail display unit 2304 may be configured to:
switch from a first display interface of the multimedia introduction information to a display interface for the detailed content of the resume in response to the confirmation trigger implemented by the recruiter on the multimedia introduction information; or
obtain a detailed content of the resume in response to the confirmation trigger implemented by the recruiter on the multimedia introduction information, switch from the first display interface of the multimedia introduction information to a second display interface of multimedia introduction information of another applicant, and switch to the display interface for the detailed content of the resume according to a triggering operation of the recruiter on the detailed content of the resume.

In implementations, the apparatus 2300 also includes:
a user display unit 2306 that displays candidate users to the recruiter, the candidate users including at least one of the following: candidate users that match recruitment conditions preset by the recruiter and are recommended by a system, and internally recommended candidate users provided by users associated with the recruiter;
a user determination unit 2308 that determines the applicant according to a selection result of the candidate users by the recruiter.

In implementations, the apparatus 2300 also includes:
an introduction display unit 2310 that displays introduction content included in the resume of the applicant when the multimedia introduction information is played.

In implementations, the apparatus also includes at least one of the following:
a first verification unit 2312 that sends a verification request to a predefined verification platform, to cause the predefined verification platform to verify at least one piece of resume content of the applicant;
a second verification unit 2314 that sends a verification request to a verified user of the predefined verification platform, to cause the verified user to verify the at least one piece of resume content of the applicant, the verified user is a user associated with the applicant.

In implementations, the apparatus 2300 also includes:
an interaction unit 2316 that exchanges communication messages between the recruiter and the applicant.

In implementations, the apparatus 2300 may further include one or more processors 2318, an input/output (I/O) interface 2320, a network interface 2322, and memory 2324. In implementations, the memory 2324 may include program units 2326 and program data 2328. The program units 2326 may include one or more of the foregoing units as described in FIG. 23.

In implementations, the memory 2324 may include a form of computer readable media such as a volatile memory, a random access memory (RAM) and/or a non-volatile memory, for example, a read-only memory (ROM) or a flash RAM. The memory 2324 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

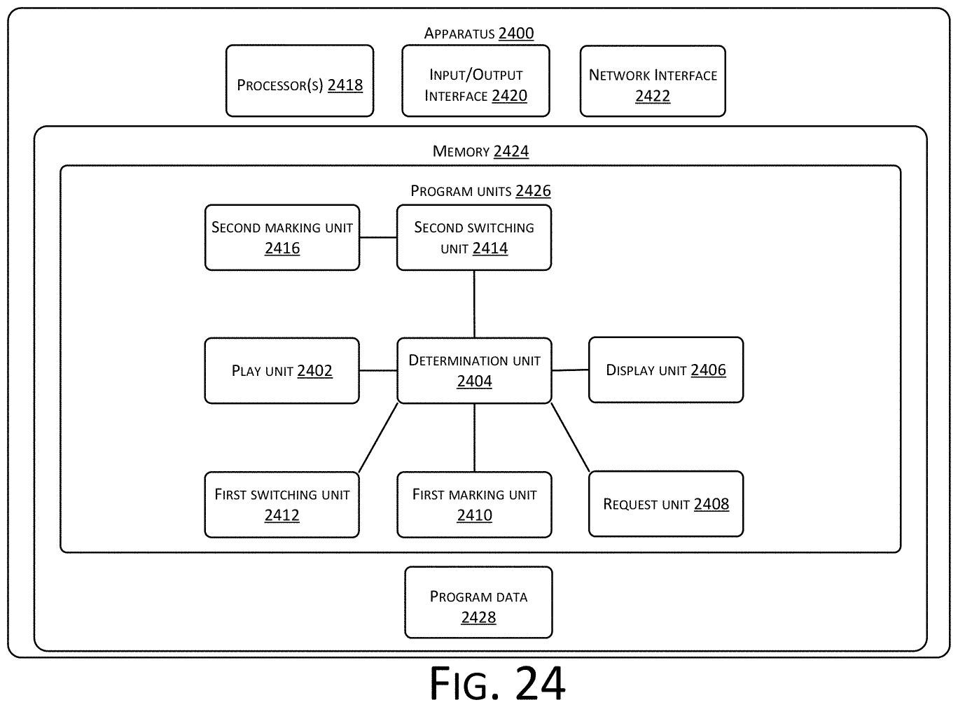

Referring to FIG. 24, in implementations, an apparatus 2400 for managing resume information may include:
a play unit 2402 that plays multimedia introduction information included in an resume of an applicant on a screen of a device; and
a determination unit 2404 that determines that a request for viewing a detailed content of the resume is detected in response to detecting a touch sliding operation toward a first direction on the screen of the device.

In implementations, the apparatus 2400 also includes:
a display unit 2406 that displays the detailed content of the resume in response to the viewing request when possessing a browsing permission for the detailed content of the resume; and
a request unit 2408 that initiates a detailed content viewing request to the applicant in response to the viewing request, when not possessing the browsing permission for the detailed content of the resume, obtains the browsing permission for the detailed content of the resume in response to a confirmation response of the applicant for the detailed content viewing request, and displays the detailed content of the resume.

In implementations, the apparatus 2400 also includes:
a first marking unit 2410 that marks the resume as a selected resume in response to the viewing request; and
a first switching unit 2412 that switches content played on the screen of the device to multimedia introduction information included in an resume of another applicant.

In implementations, the apparatus 2400 also includes:
a second switching unit 2414 that switches content played on the screen of the device to multimedia introduction information included in an resume of another applicant in response to detecting a touch sliding operation toward a second direction different from the first direction on the screen of the device.

In implementations, the apparatus 2400 also includes:
a second marking unit 2416 that marks the resume as a failed resume in response to the touch sliding operation toward the second direction.

In implementations, the apparatus 2400 may further include one or more processors 2418, an input/output (I/O) interface 2420, a network interface 2422, and memory 2424. In implementations, the memory 2424 may include a form of computer readable media as described in the foregoing description. In implementation, the memory 2424 may include program units 2426 and program data 2428. The program units 2326 may include one or more of the foregoing units as described in FIG. 24.

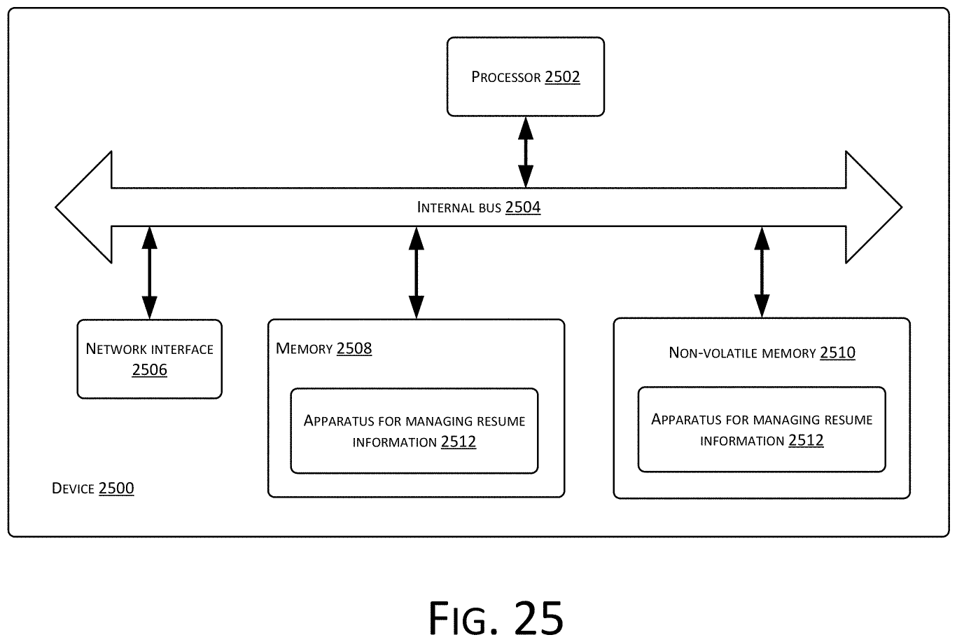

FIG. 25 is a schematic structural diagram of an example device 2500 provided by the exemplary embodiments. Referring to FIG. 25, at a hardware level, the device includes a processor 2502, an internal bus 2504, a network interface 2506, a memory 2508, and a non-volatile memory 2510, and apparently may also include hardware needed by other services. The processor 2502 reads and runs a corresponding computer program from the non-volatile memory 2510 to the memory 2508 to form an apparatus 2512 for managing resume information on a logical level. Apparently, the present disclosure does not exclude other implementations, such as logic devices or a combination of software and hardware, etc. This means that an execution body of the following flow of processing is not limited to various logic units, and can also be hardware or logic devices.

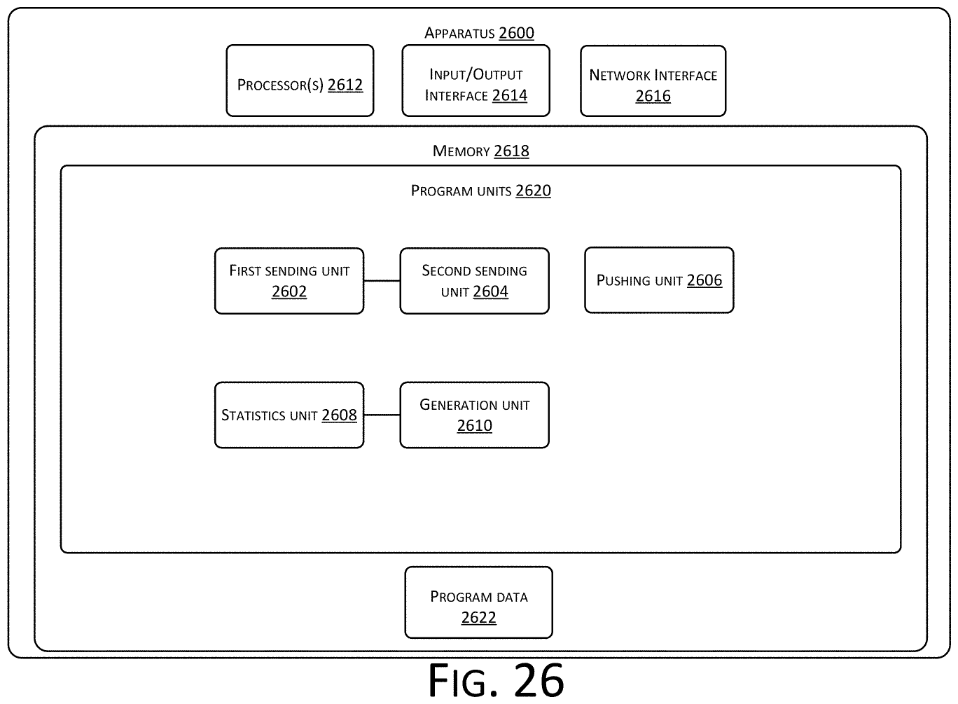

Referring to FIG. 26, in implementations, an apparatus 2600 for managing resume information may include:
a first sending unit 2602 that sends multimedia introduction information included in an resume of an applicant to a recruiter for view by the recruiter; and
a second sending unit 2604 that sends a detailed content of the resume to the recruiter for view by the recruiter according to a confirmation trigger implemented by the recruiter on the multimedia introduction information.

In implementations, the multimedia introduction information includes at least one of the following: video information, virtual reality information, augmented reality information, mixed reality information, and mediated reality information.

In implementations, the second sending unit 2604 may be configured to:
send a detailed content view request to the applicant according to the confirmation trigger implemented by the recruiter on the multimedia introduction information; and
grant a browsing permission for the detailed content of the resume to the recruiter to allow the recruiter to view according to a confirmation response of the applicant for the detailed content viewing request.

In implementations, the detailed content of the resume includes: contact information of the applicant.

In implementations, the apparatus is applied in a server device of an instant messaging application, and the detailed content view request is sent to the applicant based on the instant messaging application.

In implementations, the apparatus 2600 also includes:
a pushing unit 2606 that pushes the resume of the applicant to the recruiter when the applicant actively sends a communication message to the recruiter.

In implementations, the apparatus 2600 also includes:
a statistics unit 2608 that conducts statistics on recruitment information of applicants from a specific college; and
a generation unit 2610 that generates employment situations of students of the specific college according to a statistical result.

In implementations, the apparatus 2600 may further include one or more processors 2612, an input/output (I/O) interface 2614, a network interface 2616, and memory 2618. In implementations, the memory 2618 may include a form of computer readable media as described in the foregoing description. In implementation, the memory 2618 may include program units 2620 and program data 2622. The program units 2620 may include one or more of the foregoing units as described in FIG. 26.

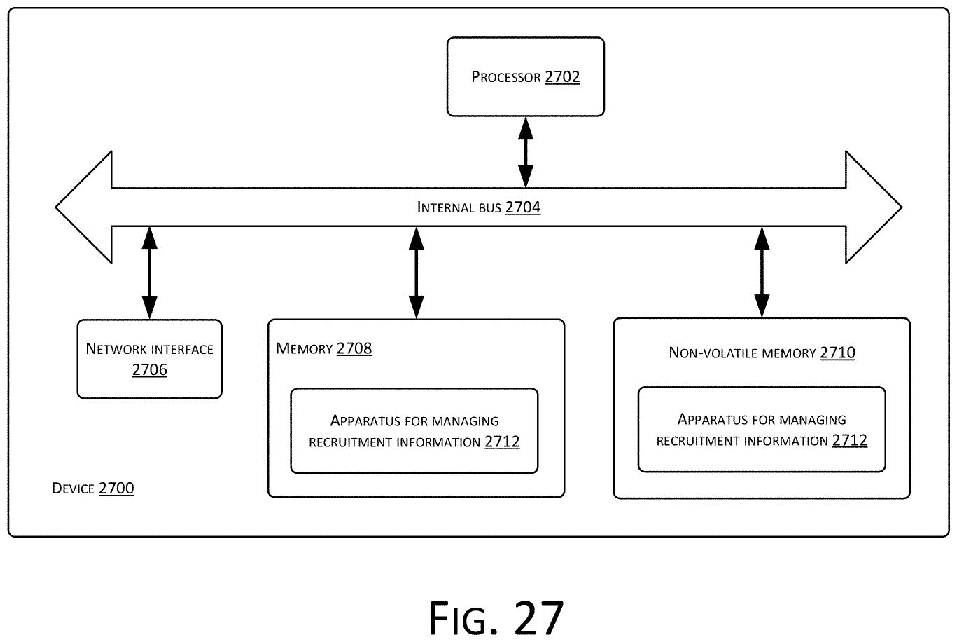

FIG. 27 is a schematic structural diagram of an example device 2700 provided by the exemplary embodiments. Referring to FIG. 27, at a hardware level, the device includes a processor 2702, an internal bus 2704, a network interface 2706, a memory 2708, and a non-volatile memory 2710, and apparently may also include hardware needed by other services. The processor 2702 reads and runs a corresponding computer program from the non-volatile memory 2710 to the memory 2708 to form an apparatus 2712 for managing recruitment information on a logical level. Apparently, in the present disclosure does not exclude other implementations, such as logic devices or a combination of software and hardware, etc. This means that an execution body of the following flow of processing is not limited to various logic units, and can also be hardware or logic devices.

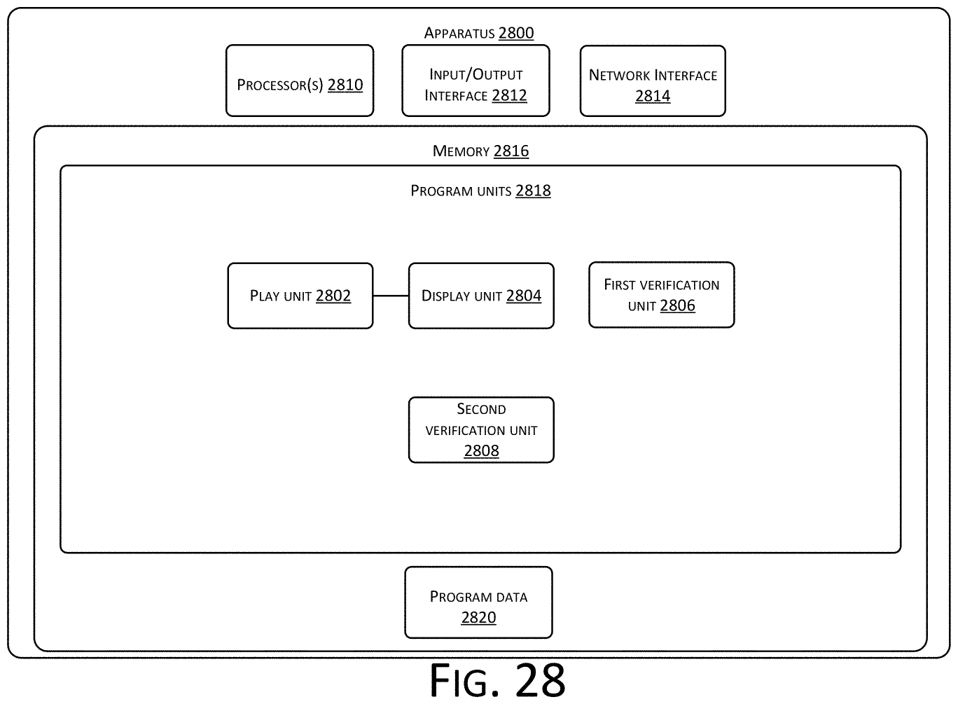

Referring to FIG. 28, in implementations, an apparatus 2800 for managing recruitment information may include:
a play unit 2802 that plays multimedia introduction information included in recruitment information; and
a display unit 2804 that displays a detailed content of the recruitment information in response to a confirmation trigger implemented by an applicant on the multimedia introduction information.

In implementations, the multimedia introduction information includes at least one of the following: video information, virtual reality information, augmented reality information, mixed reality information, and mediated reality information.

In implementations, the multimedia introduction information includes at least one of the following: introduction information about a job position and introduction information about a company to which the job position belongs.

In implementations, the display unit 2804 may be configured to:
switch from a third display interface of the multimedia introduction information to a display interface for the detailed content of the recruitment information in response to the confirmation trigger implemented by the applicant on the multimedia introduction information; or
obtain the detailed content of the recruitment information in response to the confirmation trigger implemented by the applicant on the multimedia introduction information, switch the third display interface of the multimedia introduction information to a fourth display interface of the multimedia introduction information of other recruitment information, and switch to the display interface for the detailed content of the recruitment information according to a triggering operation of the applicant on the detailed content of the recruitment information.

In implementations, the apparatus 2800 also includes at least one of the following:
a first verification unit 2806 that sends a verification request to a predefined verification platform, to cause the predefined verification platform to verify an identity of a recruiter and/or an enterprise to which the recruiter belongs;
a second verification unit 2808 that sends a verification request to a verified user of the predefined verification platform, to cause the verified user to verify the recruiter and/or the company to which the recruiter belongs, the verified user being an associated user of the recruiter.

In implementations, the apparatus 2800 may further include one or more processors 2810, an input/output (I/O) interface 2812, a network interface 2814, and memory 2816. In implementations, the memory 2816 may include a form of computer readable media as described in the foregoing description. In implementation, the memory 2816 may include program units 2818 and program data 2820. The program units 2818 may include one or more of the foregoing units as described in FIG. 28.

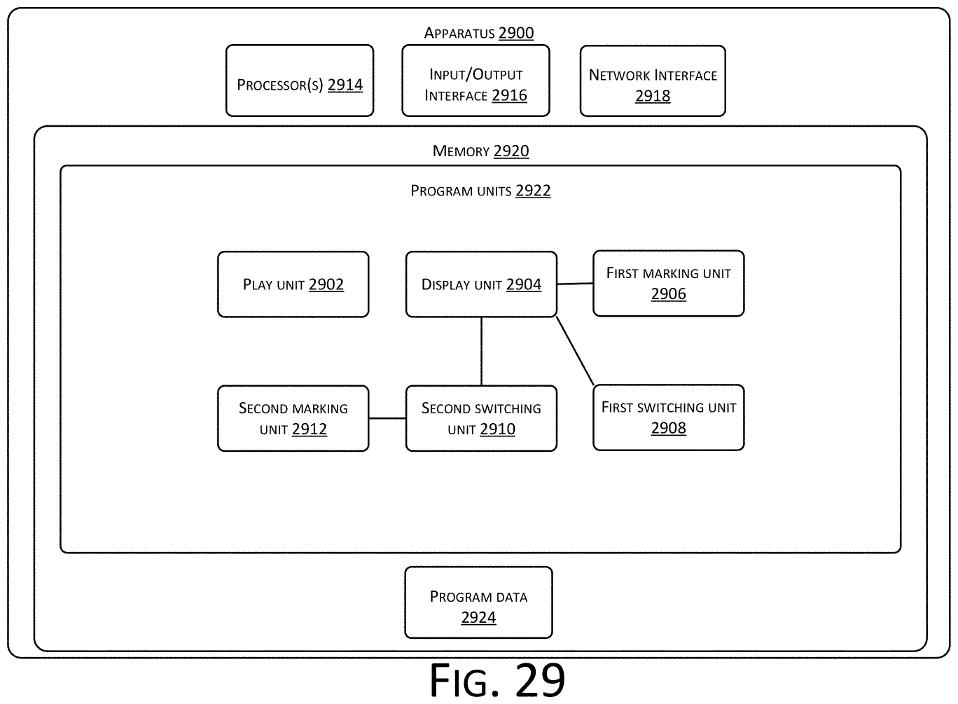

Referring to FIG. 29, in implementations, an apparatus 2900 for managing recruitment information may include:
a play unit 2902 that plays multimedia introduction information included in recruitment information on a screen of a device;
a display unit 2904 that displays a detailed content of the recruitment information in response to detecting a touch sliding operation toward a first direction on the screen of the device.

In implementations, the apparatus also includes:
a first marking unit 2906 that marks the recruitment information as target recruitment information in response to a viewing request; and
a first switching unit 2908 that switches content played on the screen of the device to multimedia introduction information included in other recruitment information.

In implementations, the apparatus 2900 also includes:
a second switching unit 2910 that switches content played on the screen of the device to multimedia introduction information included in other recruitment information in response to detecting a touch sliding operation toward a second direction different from the first direction on the screen of the device.

In implementations, the apparatus 2900 also includes:
a second marking unit 2912 that marks the recruitment information as irrelevant recruitment information in response to the touch sliding operation toward the second direction.

In implementations, the apparatus 2900 may further include one or more processors 2914, an input/output (I/O) interface 2916, a network interface 2918, and memory 2920. In implementations, the memory 2920 may include a form of computer readable media as described in the foregoing description. In implementation, the memory 2920 may include program units 2922 and program data 2924. The program units 2922 may include one or more of the foregoing units as described in FIG. 29.

The systems, devices, modules, or units described in the foregoing embodiments may be implemented by computer chips or entities, or implemented by products with certain functions. A typical device implementation is a computer. A specific form of the computer can be a personal computer, a laptop computer, a cellular phone, a camera phone, a smart phone, a personal digital assistant, a media player, a navigation device, an email receiving and sending device, and a game control console, a tablet computer, a wearable device, or a combination of any of these devices.

In a typical configuration, the computer includes one or more processors (CPUs), input/output interfaces, network interfaces, and memory.

The memory may include a form of computer readable media such as a volatile memory, a random access memory (RAM) and/or a non-volatile memory, for example, a read-only memory (ROM) or a flash RAM. The memory is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

It should also be noted that terms “including”, “containing”, or any other variants thereof are intended to cover a non-exclusive inclusion, so that a process, method, product or device including a series of elements not only includes these elements, but also includes other elements that are not explicitly listed, or include elements that are inherent to the process, method, product, or device. Without any further limitations, an element defined by a sentence “including a . . . ” does not exclude an existence of other identical elements in a process, method, commodity, or device that includes the element.

Specific embodiments of the present disclosure are described above. Other embodiments are within the scope of the appended claims. In some cases, actions or steps described in the claims may be performed in an order different from the ones in the embodiments, and still achieve desired results. In addition, a process depicted in a drawing does not necessarily require a specific order or sequential order as shown to achieve a desired result. In certain embodiments, multitasking and parallel processing are also possible or may be advantageous.

Terms used in the present disclosure are only intended for describing specific embodiments, and are not intended to limit the present disclosure. Singular forms of “a”, “said”, and “the” that are used in the present disclosure and the appended claims are also intended to include plural forms, unless the context clearly indicates other meanings. It should also be understood that a term “and/or” used herein refers to and includes any or all possible combinations of one or more associated items that are listed.

It should be understood that, although terms “first”, “second”, “third”, etc. may be used in the present disclosure to describe various types of information, these pieces of information should not be limited to these terms. These terms are only used to distinguish the same type of information from each other. For example, without departing from the scope of the present disclosure, first information may also be referred to as second information, and similarly, the second information may also be referred to as first information. Depending on the context, a word “if” as used herein can be interpreted as “when” or “at the time when” or “in response to a determination of”.

The above descriptions are only exemplary embodiments of the present disclosure, and are not intended to limit the present disclosure. All modifications, equivalent replacements, improvements, etc. that are made within the spirit and principles of the present disclosure shall be included in the scope of protection of the present disclosure.

The present disclosure can be further understood using the following clauses.

Clause 1: A method for managing resume information, comprising: playing multimedia introduction information included in an resume of an applicant; and displaying a detailed content of the resume in response to a confirmation trigger implemented by the applicant on the multimedia introduction information.

Clause 2: The method of Clause 1, wherein the multimedia introduction information comprises at least one of: video information, virtual reality information, augmented reality information, mixed reality information, and mediated reality information.

Clause 3: The method of Clause 1, wherein displaying the detailed content of the resume in response to the confirmation trigger implemented by the applicant on the multimedia introduction information comprises: sending a detailed content view request to the applicant in response to the confirmation trigger implemented by the recruiter on the multimedia introduction information; and obtaining a browsing permission for a detailed content of the resume, and display the detailed content of the resume, according to a confirmation response of the applicant for the detailed content view request.

Clause 4: The method of Clause 3, wherein the detailed content of the resume comprises contact information of the applicant.

Clause 5: The method of Clause 3, wherein the method is applied in a client device of an instant messaging application, and the detailed content view request is sent to the applicant based on the instant messaging application.

Clause 6: The method of Clause 1, wherein displaying the detailed content of the resume in response to the confirmation trigger implemented by the applicant on the multimedia introduction information comprises: switching from a first display interface of the multimedia introduction information to a display interface for the detailed content of the resume in response to the confirmation trigger implemented by the recruiter on the multimedia introduction information; or obtaining a detailed content of the resume in response to the confirmation trigger implemented by the recruiter on the multimedia introduction information, switching from the first display interface of the multimedia introduction information to a second display interface of multimedia introduction information of another applicant, and switching to the display interface for the detailed content of the resume according to a triggering operation of the recruiter on the detailed content of the resume.

Clause 7: The method of Clause 1, further comprising: displaying candidate users to the recruiter, the candidate users including at least one of: candidate users that match recruitment conditions preset by the recruiter and are recommended by a system, and internally recommended candidate users provided by users associated with the recruiter; and determining the applicant according to a selection result of the candidate users by the recruiter.

Clause 8: The method of Clause 1, further comprising: displaying introduction content included in the resume of the applicant when the multimedia introduction information is played.

Clause 9: The method of Clause 1, further comprising at least one of: sending a verification request to a predefined verification platform, to cause the predefined verification platform to verify at least one piece of resume content of the applicant; or sending a verification request to a verified user of the predefined verification platform, to cause the verified user to verify the at least one piece of resume content of the applicant, the verified user is a user associated with the applicant.

Clause 10: The method of Clause 1, further comprising: exchanging communication messages between the recruiter and the applicant.

Clause 11: A method for managing resume information, comprising: sending multimedia introduction information included in an resume of an applicant to a recruiter for view by the recruiter; and sending a detailed content of the resume to the recruiter for view by the recruiter in response to a confirmation trigger of the multimedia introduction information implemented by the recruiter.

Clause 12: The method of Clause 11, wherein the multimedia introduction information comprises at least one of: video information, virtual reality information, augmented reality information, mixed reality information, and mediated reality information.

Clause 13: The method of Clause 11, wherein sending the detailed content of the resume to the recruiter for view by the recruiter in response to the confirmation trigger of the multimedia introduction information implemented by the recruiter comprises: sending a detailed content view request to the applicant according to the confirmation trigger implemented by the recruiter on the multimedia introduction information; and granting a browsing permission for the detailed content of the resume to the recruiter to allow the recruiter to view according to a confirmation response of the applicant for the detailed content viewing request.

Clause 14: The method of Clause 13, wherein the detailed content of the resume comprises: contact information of the applicant.

Clause 15: The method of Clause 13, wherein the method is applied in a server device of an instant messaging application, and the detailed content view request is sent to the applicant based on the instant messaging application.

Clause 16: The method of Clause 11, further comprising: pushing the resume of the applicant to the recruiter when the applicant actively sends a communication message to the recruiter.

Clause 17: The method of Clause 11, further comprising: conducting statistics on recruitment information of applicants from a specific college; and generating employment situations of students of the specific college according to a statistical result.

Clause 18: A method for managing recruitment information, comprising: playing multimedia introduction information included in recruitment information; and displaying a detailed content of the recruitment information in response to a confirmation trigger implemented by an applicant on the multimedia introduction information.

Clause 19: The method of Clause 18, wherein the multimedia introduction information comprises at least one of: video information, virtual reality information, augmented reality information, mixed reality information, and mediated reality information.

Clause 20: The method of Clause 18, wherein the multimedia introduction information comprises at least one of: introduction information about a job position and introduction information about a company to which the job position belongs.

Clause 21: The method of Clause 18, wherein displaying the detailed content of the recruitment information in response to the confirmation trigger implemented by the applicant on the multimedia introduction information comprises: switching from a third display interface of the multimedia introduction information to a display interface for the detailed content of the recruitment information in response to the confirmation trigger implemented by the applicant on the multimedia introduction information; or obtaining the detailed content of the recruitment information in response to the confirmation trigger implemented by the applicant on the multimedia introduction information, switching the third display interface of the multimedia introduction information to a fourth display interface of the multimedia introduction information of other recruitment information, and switching to the display interface for the detailed content of the recruitment information according to a triggering operation of the applicant on the detailed content of the recruitment information.

Clause 22: The method of Clause 18, further comprising at least one of: sending a verification request to a predefined verification platform, to cause the predefined verification platform to verify an identity of a recruiter and/or an enterprise to which the recruiter belongs; or sending a verification request to a verified user of the predefined verification platform, to cause the verified user to verify the recruiter and/or the company to which the recruiter belongs, the verified user being an associated user of the recruiter.

Clause 23: A method for managing resume information, comprising: playing multimedia introduction information included in an resume of an applicant on a screen of a device; and determining that a request for viewing a detailed content of the resume is detected in response to detecting a touch sliding operation toward a first direction on the screen of the device.

Clause 24: The method of Clause 23, further comprising: displaying the detailed content of the resume in response to the viewing request when possessing a browsing permission for the detailed content of the resume; and when not possessing the browsing permission for the detailed content of the resume, initiating a detailed content viewing request to the applicant in response to the viewing request, obtaining the browsing permission for the detailed content of the resume in response to a confirmation response of the applicant for the detailed content viewing request, and displaying the detailed content of the resume.

Clause 25: The method of Clause 23, further comprising: marking the resume as a selected resume in response to the viewing request; and switching content played on the screen of the device to multimedia introduction information included in an resume of another applicant.

Clause 26: The method of Clause 23, further comprising: switching content played on the screen of the device to multimedia introduction information included in an resume of another applicant in response to detecting a touch sliding operation toward a second direction different from the first direction on the screen of the device.

Clause 27: The method of Clause 26, further comprising: marking the resume as a failed resume in response to the touch sliding operation toward the second direction.

Clause 28: A method for managing recruitment information, comprising: playing multimedia introduction information included in recruitment information on a screen of a device; displaying a detailed content of the recruitment information in response to detecting a touch sliding operation toward a first direction on the screen of the device.

Clause 29: The method of Clause 28, further comprising: marking the recruitment information as target recruitment information in response to a viewing request; and switching content played on the screen of the device to multimedia introduction information included in other recruitment information.

Clause 30: The method of Clause 28, further comprising: switching unit content played on the screen of the device to multimedia introduction information included in other recruitment information in response to detecting a touch sliding operation toward a second direction different from the first direction on the screen of the device.

Clause 31: The method of Clause 30, further comprising: marking the recruitment information as irrelevant recruitment information in response to the touch sliding operation toward the second direction.

Clause 32: An apparatus for managing resume information, comprising: a play unit that plays multimedia introduction information included in an resume of an applicant; and a detail display unit that displays a detailed content of the resume in response to a confirmation trigger implemented by a recruiter on the multimedia introduction information.

Clause 33: The apparatus of Clause 32, wherein the multimedia introduction information comprises at least one of: video information, virtual reality information, augmented reality information, mixed reality information, and mediated reality information.

Clause 34: The apparatus of Clause 32, wherein the detail display unit is specifically configured to: send a detailed content view request to the applicant in response to the confirmation trigger implemented by the recruiter on the multimedia introduction information; and obtain a browsing permission for a detailed content of the resume, and display the detailed content of the resume, according to a confirmation response of the applicant for the detailed content view request.

Clause 35: The apparatus of Clause 34, wherein the detailed content of the resume comprises contact information of the applicant.

Clause 36: The apparatus of Clause 34, wherein the apparatus is applied in a client device of an instant messaging application, and the detailed content view request is sent to the applicant based on the instant messaging application.

Clause 37: The apparatus of Clause 32, wherein the detail display unit is specifically configured to: switch from a first display interface of the multimedia introduction information to a display interface for the detailed content of the resume in response to the confirmation trigger implemented by the recruiter on the multimedia introduction information; or obtain a detailed content of the resume in response to the confirmation trigger implemented by the recruiter on the multimedia introduction information, switch from the first display interface of the multimedia introduction information to a second display interface of multimedia introduction information of another applicant, and switch to the display interface for the detailed content of the resume according to a triggering operation of the recruiter on the detailed content of the resume.

Clause 38: The apparatus of Clause 32, further comprising: a user display unit that displays candidate users to the recruiter, the candidate users including at least one of the following: candidate users that match recruitment conditions preset by the recruiter and are recommended by a system, and internally recommended candidate users provided by users associated with the recruiter; and a user determination unit that determines the applicant according to a selection result of the candidate users by the recruiter.

Clause 39: The apparatus of Clause 32, further comprising: an introduction display unit that displays introduction content included in the resume of the applicant when the multimedia introduction information is played.

Clause 40: The apparatus of Clause 32, further comprising at least one of: a first verification unit that sends a verification request to a predefined verification platform, to cause the predefined verification platform to verify at least one piece of resume content of the applicant; or a second verification unit that sends a verification request to a verified user of the predefined verification platform, to cause the verified user to verify the at least one piece of resume content of the applicant, the verified user is a user associated with the applicant.

Clause 41: The apparatus of Clause 32, further comprising: an interaction unit that exchanges communication messages between the recruiter and the applicant.

Clause 42: An apparatus for managing resume information, comprising: a first sending unit that sends multimedia introduction information included in an resume of an applicant to a recruiter for view by the recruiter; and a second sending unit that sends a detailed content of the resume to the recruiter for view by the recruiter according to a confirmation trigger implemented by the recruiter on the multimedia introduction information.

Clause 43: The apparatus of Clause 42, wherein the multimedia introduction information comprises at least one of: video information, virtual reality information, augmented reality information, mixed reality information, and mediated reality information.

Clause 44: The apparatus of Clause 42, wherein the second sending unit is specifically configured to: send a detailed content view request to the applicant according to the confirmation trigger implemented by the recruiter on the multimedia introduction information; and grant a browsing permission for the detailed content of the resume to the recruiter to allow the recruiter to view according to a confirmation response of the applicant for the detailed content viewing request.

Clause 45: The apparatus of Clause 44, wherein the detailed content of the resume includes contact information of the applicant.

Clause 46: The apparatus of Clause 44, wherein the apparatus is applied in a server device of an instant messaging application, and the detailed content view request is sent to the applicant based on the instant messaging application.

Clause 47: The apparatus of Clause 42, further comprising: a pushing unit that pushes the resume of the applicant to the recruiter when the applicant actively sends a communication message to the recruiter.

Clause 48: The apparatus of Clause 42, further comprising: a statistics unit that conducts statistics on recruitment information of applicants from a specific college; and a generation unit that generates employment situations of students of the specific college according to a statistical result.

Clause 49: An apparatus for managing recruitment information, comprising: a play unit that plays multimedia introduction information included in recruitment information; and a display unit that displays a detailed content of the recruitment information in response to a confirmation trigger implemented by an applicant on the multimedia introduction information.

Clause 50: The apparatus of Clause 49, wherein the multimedia introduction information comprises at least one of: video information, virtual reality information, augmented reality information, mixed reality information, and mediated reality information.

Clause 51: The apparatus of Clause 49, wherein the multimedia introduction information comprises at least one of: introduction information about a job position and introduction information about a company to which the job position belongs.

Clause 52: The apparatus of Clause 49, wherein the display unit is specifically configured to: switch from a third display interface of the multimedia introduction information to a display interface for the detailed content of the recruitment information in response to the confirmation trigger implemented by the applicant on the multimedia introduction information; or obtain the detailed content of the recruitment information in response to the confirmation trigger implemented by the applicant on the multimedia introduction information, switch the third display interface of the multimedia introduction information to a fourth display interface of the multimedia introduction information of other recruitment information, and switch to the display interface for the detailed content of the recruitment information according to a triggering operation of the applicant on the detailed content of the recruitment information.

Clause 53: The apparatus of Clause 49, further comprising at least one of: a first verification unit that sends a verification request to a predefined verification platform, to cause the predefined verification platform to verify an identity of a recruiter and/or an enterprise to which the recruiter belongs; or a second verification unit that sends a verification request to a verified user of the predefined verification platform, to cause the verified user to verify the recruiter and/or the company to which the recruiter belongs, the verified user being an associated user of the recruiter.

Clause 54: An apparatus for managing resume information, comprising: a play unit that plays multimedia introduction information included in an resume of an applicant on a screen of a device; and a determination unit that determines that a request for viewing a detailed content of the resume is detected in response to detecting a touch sliding operation toward a first direction on the screen of the device.

Clause 55: The apparatus of Clause 54, further comprising: a display unit that displays the detailed content of the resume in response to the viewing request when possessing a browsing permission for the detailed content of the resume; and a request unit that initiates a detailed content viewing request to the applicant in response to the viewing request, when not possessing the browsing permission for the detailed content of the resume, obtains the browsing permission for the detailed content of the resume in response to a confirmation response of the applicant for the detailed content viewing request, and displays the detailed content of the resume.

Clause 56: The apparatus of Clause 54, further comprising: a first marking unit that marks the resume as a selected resume in response to the viewing request; and a first switching unit that switches content played on the screen of the device to multimedia introduction information included in an resume of another applicant.

Clause 57: The apparatus of Clause 54, further comprising: a second switching unit that switches content played on the screen of the device to multimedia introduction information included in an resume of another applicant in response to detecting a touch sliding operation toward a second direction different from the first direction on the screen of the device.

Clause 58: The apparatus of Clause 57, further comprising: a second marking unit that marks the resume as a failed resume in response to the touch sliding operation toward the second direction.

Clause 59: An apparatus for managing recruitment information, comprising: a play unit that plays multimedia introduction information included in recruitment information on a screen of a device; and a display unit that displays a detailed content of the recruitment information in response to detecting a touch sliding operation toward a first direction on the screen of the device.

Clause 60: The apparatus of Clause 59, further comprising: a first marking unit that marks the recruitment information as target recruitment information in response to a viewing request; and a first switching unit that switches content played on the screen of the device to multimedia introduction information included in other recruitment information.

Clause 61: The apparatus of Clause 59, further comprising: a second switching unit that switches content played on the screen of the device to multimedia introduction information included in other recruitment information in response to detecting a touch sliding operation toward a second direction different from the first direction on the screen of the device.

Clause 62: The apparatus of Clause 61, further comprising: a second marking unit that marks the recruitment information as irrelevant recruitment information in response to the touch sliding operation toward the second direction.

What is claimed is:

1. A method implemented by a computing device, the method comprising:
playing multimedia introduction information included in an resume of an applicant; and
displaying a detailed content of the resume in response to a confirmation trigger implemented by the applicant on the multimedia introduction information.

2. The method of claim 1, wherein the multimedia introduction information comprises at least one of: video information, virtual reality information, augmented reality information, mixed reality information, and mediated reality information.

3. The method of claim 1, wherein displaying the detailed content of the resume in response to the confirmation trigger implemented by the applicant on the multimedia introduction information comprises:
sending a detailed content view request to the applicant in response to the confirmation trigger implemented by the recruiter on the multimedia introduction information; and
obtaining a browsing permission for a detailed content of the resume, and display the detailed content of the resume, according to a confirmation response of the applicant for the detailed content view request.

4. The method of claim 3, wherein the detailed content of the resume comprises contact information of the applicant.

5. The method of claim 3, wherein the method is applied in a client device of an instant messaging application, and the detailed content view request is sent to the applicant based on the instant messaging application.

6. The method of claim 1, wherein displaying the detailed content of the resume in response to the confirmation trigger implemented by the applicant on the multimedia introduction information comprises:
switching from a first display interface of the multimedia introduction information to a display interface for the detailed content of the resume in response to the confirmation trigger implemented by the recruiter on the multimedia introduction information; or
obtaining a detailed content of the resume in response to the confirmation trigger implemented by the recruiter on the multimedia introduction information, switching from the first display interface of the multimedia introduction information to a second display interface of multimedia introduction information of another applicant, and switching to the display interface for the detailed content of the resume according to a triggering operation of the recruiter on the detailed content of the resume.

7. The method of claim 1, further comprising:
displaying candidate users to the recruiter, the candidate users including at least one of: candidate users that match recruitment conditions preset by the recruiter and are recommended by a system, and internally recommended candidate users provided by users associated with the recruiter; and
determining the applicant according to a selection result of the candidate users by the recruiter.

8. The method of claim 1, further comprising:
displaying introduction content included in the resume of the applicant when the multimedia introduction information is played.

9. The method of claim 1, further comprising at least one of:
sending a verification request to a predefined verification platform, to cause the predefined verification platform to verify at least one piece of resume content of the applicant; or
sending a verification request to a verified user of the predefined verification platform, to cause the verified user to verify the at least one piece of resume content of the applicant, the verified user is a user associated with the applicant.

10. The method of claim 1, further comprising:
exchanging communication messages between the recruiter and the applicant.

11. One or more computer readable media storing executable instructions that, when executed by one or more processors, cause the one or more processors to perform acts comprising:
sending multimedia introduction information included in an resume of an applicant to a recruiter for view by the recruiter; and
sending a detailed content of the resume to the recruiter for view by the recruiter in response to a confirmation trigger of the multimedia introduction information implemented by the recruiter.

12. The one or more computer readable media of claim 11, wherein the multimedia introduction information comprises at least one of: video information, virtual reality information, augmented reality information, mixed reality information, and mediated reality information.

13. The one or more computer readable media of claim 11, wherein sending the detailed content of the resume to the recruiter for view by the recruiter in response to the confirmation trigger of the multimedia introduction information implemented by the recruiter comprises:
sending a detailed content view request to the applicant according to the confirmation trigger implemented by the recruiter on the multimedia introduction information; and
granting a browsing permission for the detailed content of the resume to the recruiter to allow the recruiter to view according to a confirmation response of the applicant for the detailed content viewing request.

14. The one or more computer readable media of claim 13, wherein the detailed content of the resume comprises: contact information of the applicant.

15. The one or more computer readable media of claim 13, wherein the method is applied in a server device of an instant messaging application, and the detailed content view request is sent to the applicant based on the instant messaging application.

16. The one or more computer readable media of claim 11, the acts further comprising:
pushing the resume of the applicant to the recruiter when the applicant actively sends a communication message to the recruiter.

17. The one or more computer readable media of claim 11, the acts further comprising:
conducting statistics on recruitment information of applicants from a specific college; and
generating employment situations of students of the specific college according to a statistical result.

18. An apparatus comprising:
one or more processors;
memory;
a play unit stored in the memory and executable by the one or more processors that is configured to play multimedia introduction information included in an resume of an applicant on a screen of a device; and
a determination unit stored in the memory and executable by the one or more processors to that is configured to determine that a request for viewing a detailed content of the resume is detected in response to detecting a touch sliding operation toward a first direction on the screen of the device.

19. The apparatus of claim 18, further comprising:
a display unit stored in the memory and executable by the one or more processors to that is configured to display the detailed content of the resume in response to the viewing request when possessing a browsing permission for the detailed content of the resume; and
a request unit stored in the memory and executable by the one or more processors to that is configured to initiate a detailed content viewing request to the applicant in response to the viewing request, when not possessing the browsing permission for the detailed content of the resume, obtain the browsing permission for the detailed content of the resume in response to a confirmation response of the applicant for the detailed content viewing request, and display the detailed content of the resume.

20. The apparatus of claim 18, further comprising:
a first marking unit stored in the memory and executable by the one or more processors to that is configured to mark the resume as a selected resume in response to the viewing request;
a first switching unit stored in the memory and executable by the one or more processors to that is configured to switch content played on the screen of the device to multimedia introduction information included in an resume of another applicant;
a second switching unit that switches content played on the screen of the device to multimedia introduction information included in an resume of another applicant in response to detecting a touch sliding operation toward a second direction different from the first direction on the screen of the device; and
a second marking unit that marks the resume as a failed resume in response to the touch sliding operation toward the second direction.
